(19) United States
(12) Patent Application Publication
(10) Pub. No.: US 2026/0188220 A1
(43) Pub. Date: Jul. 2, 2026

(54) DISPLAY PANEL AND DISPLAY DEVICE INCLUDING THE SAME

(71) Applicant: LG Display Co., Ltd., Seoul (KR)

(72) Inventors: Dong Kyu LEE, Paju-si (KR); Dong Kyu KIM, Paju-si (KR)

(73) Assignee: LG Display Co., Ltd., Seoul (KR)

(21) Appl. No.: 19/308,897

(22) Filed: Aug. 25, 2025

(30) Foreign Application Priority Data
Dec. 31, 2024 (KR) 10-2024-0201636

(51) Int. Cl. G09G 3/3233

(52) U.S. Cl. CPC G09G 3/3233; G09G 2300/0819; G09G 2300/0852; G09G 2300/0861; G09G 2310/0297; G09G 2310/08; G09G 2320/068; G09G 2380/10

(57) ABSTRACT

A display panel and a display device including the same are discussed. The display panel can include a pixel circuit connected to a data line, a plurality of gate lines, a plurality of constant voltage nodes, a first light-emitting element, and a second light-emitting element. The display panel can further include a first gate driver configured to output a first scan signal, a second gate driver configured to output a second scan signal, and a multiplexer configured to select the first scan signal, the second scan signal, and a gate-off voltage, and output them to corresponding gate lines.

### CROSS-REFERENCE TO RELATED APPLICATION

This application claims priority to and the benefit of Korean Patent Application No. 10-2024-0201636, filed in the Republic of Korea on Dec. 31, 2024, the disclosure of which is hereby expressly incorporated by reference in its entirety.

### BACKGROUND

### Field

The present disclosure relates to a display panel with a variable viewing angle and a display device including the same.

### Discussion of the Related Art

A viewing angle variable technology is being applied to display devices. The variable viewing angle technology allows video content or visual information reproduced on a display device to be visible only to a user within a narrow viewing angle range, or to multiple users within a wide viewing angle range.

As the market for future vehicles such as electric vehicles and autonomous vehicles expands, the demand for in-vehicle display devices is growing rapidly. Research is being conducted on how to split the screen of an in-vehicle display device so that one portion of the screen is controlled at a narrow viewing angle while another portion is controlled at a wide viewing angle. This technology can display private content or information that only a specific user can see or would like to see using pixels driven at the narrow viewing angle, while displaying shared content that multiple users can view together using the pixels driven at the wide viewing angle. To achieve this, a pixel technology that can freely control each pixel at the narrow viewing angle and the wide viewing angle is needed.

### SUMMARY OF THE DISCLOSURE

Embodiments of the present disclosure solve or address the above-described and other shortcomings and/or problems associated with the related art.

Aspects of the present disclosure provide a display device capable of separating a viewing angle for pixel data of different contents without adding a channel of a data driver in each pixel and enhancing a privacy protection function.

The problems addressed by the embodiments of the present disclosure are not limited to those described above, and other problems not described will be clearly understood by those skilled in the art from the following description.

A display panel according to aspects of the present disclosure includes a pixel circuit connected to a data line, a plurality of gate lines, a plurality of constant voltage nodes, a first light-emitting element, and a second light-emitting element; a first gate driver configured to output a first scan signal; a second gate driver configured to output a second scan signal; and a multiplexer configured to select the first scan signal, the second scan signal, and a gate-off voltage and output them to corresponding gate lines.

According to aspects of the present disclosure, the multiplexer can select one of the first scan signal and the gate-off voltage and output a first-first scan signal to a first gate line. The multiplexer can select one of the second scan signal and the gate-off voltage and output a second-first scan signal to a second gate line. The multiplexer can select one of the first scan signal and the gate-off voltage and output a first-second scan signal to a third gate line. The multiplexer can select one of the second scan signal and the gate-off voltage and output a second-second scan signal to a fourth gate line.

According to aspects of the present disclosure, the pixel circuit can include a first driver connected to the first gate line, the second gate line, and the first light-emitting element; a second driver connected to the third gate line, the fourth gate line, and the second light-emitting element; and a shared switch part connected to the data line, the first driver, and the second driver.

According to aspects of the present disclosure, the display panel can further include a third gate driver configured to output a third scan signal, a fourth gate driver configured to output a first emission signal, a fifth gate driver configured to output a second emission signal, and a sixth gate driver configured to output a third emission signal.

According to aspects of the present disclosure, the first driver can include a first driving transistor including a gate electrode connected to a first node, a first electrode connected to a second node, and a second electrode connected to a third node; a first capacitor connected between a first constant voltage node and the first node; a first switch transistor including a gate electrode connected to the second gate line to which the second-first scan signal is applied, a first electrode connected to the first node, and a second electrode connected to the third node; a second switch transistor including a gate electrode connected to the first gate line to which the first-first scan signal is applied, a first electrode connected to the first node, and a second electrode connected to a third constant voltage node; and a third switch transistor including a gate electrode to which the second emission signal is applied, a first electrode connected to the third node, and a second electrode connected to a fourth node, and the first light-emitting element includes an anode electrode connected to the fourth node and a cathode electrode connected to a second constant voltage node. Each of the first switch transistor, the second switch transistor, and the third switch transistor can be turned on in response to a gate-on voltage and is turned off in response to the gate-off voltage.

According to aspects of the present disclosure, the second driver can include a second driving transistor including a gate electrode connected to a fifth node, a first electrode connected to the second node, and a second electrode connected to a sixth node; a second capacitor connected between the first constant voltage node and the fifth node; a fourth switch transistor including a gate electrode connected to the fourth gate line to which the second-second scan signal is applied, a first electrode connected to the fifth node, and a second electrode connected to the sixth node; a fifth switch transistor including a gate electrode connected to the third gate line to which the first-second scan signal is applied, a first electrode connected to the fifth node, and a second electrode connected to the third constant voltage node; and a sixth switch transistor including a gate electrode to which the third emission signal is applied, a first electrode connected to the sixth node, and a second electrode connected to a seventh node. The second light-emitting element can include an anode electrode connected to the seventh node and a cathode electrode connected to the second constant voltage node. Each of the fourth switch transistor, the fifth switch transistor, and the sixth switch transistor can be turned on in response to the gate-on voltage and is turned off in response to the gate-off voltage.

According to aspects of the present disclosure, the shared switch part can include a seventh switch transistor including a gate electrode to which the second scan signal is applied, a first electrode connected to the data line, and a second electrode connected to the second node; an eighth switch transistor including a gate electrode to which the first emission signal is applied, a first electrode connected to the first constant voltage node, and a second electrode connected to the second node; a ninth switch transistor including a gate electrode to which the third scan signal is applied, a first electrode connected to the third constant voltage node, and a second electrode connected to the fourth node; and a tenth switch transistor including a gate electrode to which the third scan signal is applied, a first electrode connected to the third constant voltage node, and a second electrode connected to the seventh node. Each of the seventh switch transistor, the eighth switch transistor, the ninth switch transistor, and the tenth switch transistor can be turned on in response to the gate-on voltage and is turned off in response to the gate-off voltage.

According to aspects of the present disclosure, the display panel can further include a third gate driver configured to output a first emission signal; and a fourth gate driver configured to output a second emission signal.

According to aspects of the present disclosure, the first driver can include a first driving transistor including a gate electrode connected to a first node, a first electrode connected to a second node to which a constant voltage is applied, and a second electrode connected to a third node; a first capacitor connected between the first node and an eighth node; a first switch transistor including a gate electrode connected to the first gate line to which the first-first scan signal is applied, a first electrode connected to the first node, and a second electrode connected to the third node; a second switch transistor including a gate electrode to which the first emission signal is applied, a first electrode connected to the eighth node, and a second electrode connected to a third constant voltage node; a third switch transistor including a gate electrode to which the first emission signal is applied, a first electrode connected to the third node, and a second electrode connected to a fourth node; and a fourth switch transistor including a gate electrode connected to the second gate line to which the second-first scan signal is applied, a first electrode connected to the data line, and a second electrode connected to the eighth node. The first light-emitting element can include an anode electrode connected to the fourth node and a cathode electrode connected to a second constant voltage node. Each of the first switch transistor, the second switch transistor, the third switch transistor, and the fourth switch transistor can be turned on in response to a gate-on voltage and is turned off in response to the gate-off voltage.

According to aspects of the present disclosure, the second driver can include a second driving transistor including a gate electrode connected to a fifth node, a first electrode connected to the second node, and a second electrode connected to a sixth node; a second capacitor connected between the fifth node and a ninth node; a fifth switch transistor including a gate electrode connected to the third gate line to which the first-second scan signal is applied, a first electrode connected to the fifth node, and a second electrode connected to the sixth node; a sixth switch transistor including a gate electrode to which the second emission signal is applied, a first electrode connected to the ninth node, and a second electrode connected to the third constant voltage node; a seventh switch transistor including a gate electrode to which the second emission signal is applied, a first electrode connected to the sixth node, and a second electrode connected to a seventh node; and an eighth switch transistor including a gate electrode connected to the fourth gate line to which the second-second scan signal is applied, a first electrode connected to the data line, and a second electrode connected to the ninth node. The second light-emitting element can include an anode electrode connected to the seventh node and a cathode electrode connected to the second constant voltage node. Each of the fifth switch transistor, the sixth switch transistor, the seventh switch transistor, and the eighth switch transistor can be turned on in response to the gate-on voltage and is turned off in response to the gate-off voltage.

According to aspects of the present disclosure, the shared switch part can include a ninth switch transistor including a gate electrode to which the first scan signal is applied, a first electrode connected to the third constant voltage node, and a second electrode connected to the fourth node; and a tenth switch transistor including a gate electrode to which the first scan signal is applied, a first electrode connected to the third constant voltage node, and a second electrode connected to the seventh node. Each of the ninth switch transistor and the tenth switch transistor can be turned on in response to the gate-on voltage and is turned off in response to the gate-off voltage.

A display device according to aspects of the present disclosure includes a display panel in which a pixel circuit connected to a data line, a plurality of gate lines, a plurality of constant voltage nodes, a first light-emitting element, and a second light-emitting element is arranged, and including a first gate driver configured to output a first scan signal, a second gate driver configured to output a second scan signal, and a multiplexer configured to select the first scan signal, the second scan signal, and a gate-off voltage and output them to corresponding gate lines; and a data driver configured to supply a data voltage to the data line.

According to the embodiments of the present disclosure, it is possible to adjust the viewing angle of the pixels according to the user's usage environment and the need for privacy protection of private content. Therefore, the present disclosure provides a display device capable of not only achieving low power and process optimization, but also separating pixel data of private content and pixel data of shared content in each pixel and enhancing a privacy protection function.

According to the embodiments of the present disclosure, it is possible to protect privacy by reproducing a video of private content requiring privacy protection with a narrow viewing angle without interfering with watching a video of shared content.

According to the embodiments of the present disclosure, since it is possible to reproduce a video of shared content with a wide viewing angle and reproduce a video of private content with a narrow viewing angle in one pixel, it is possible to prevent or minimize a phenomenon that some pixels have a black grayscale, for example, look black when a wide viewing angle video and a narrow viewing angle video are displayed together.

According to the embodiments of the present disclosure, it is possible to reproduce shared content and private content with different viewing angles in pixels without increasing the number of data lines and channels of a data driver.

According to aspects of the present disclosure, the display device can select a gate-off voltage and a gate signal outputted from a gate driver according to a mode using a multiplexer and can transmit them to pixels. As a result, the present disclosure can reduce the size of a non-display area in which the gate driver is located in the display panel, thereby facilitating a narrow bezel design.

A low temperature poly silicon thin film transistor (LTPS TFT) has a larger leakage current in an off-state compared to an oxide TFT, and therefore, it can be difficult to drive an LTPS TFT-based display panel at a low frequency without flicker. The present disclosure is capable of simultaneously implementing two viewing angles in an LTPS TFT-based display panel without flicker by driving pixels at a frequency of 60 Hz or higher in different viewing angle modes at intervals of one frame.

The present disclosure can cause a pixel to emit light at high luminance by charging the same voltage to the first and second capacitors of the pixel circuit.

The effects of the present disclosure are not limited to the above-mentioned effects, and other effects not explicitly mentioned will be clearly understood by those skilled in the art based on the description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a part diagram illustrating a display device according to one or more embodiments of the present disclosure;

FIGS. 2A and 2B are drawings illustrating one example of a gate driver according to one or more embodiments of the present disclosure;

FIG. 3 is a circuit diagram illustrating a pixel circuit according to one or more embodiments of the present disclosure;

FIG. 4 is a diagram illustrating an example of lenses arranged in sub-pixels according to one or more embodiments of the present disclosure;

FIG. 5 is a circuit diagram illustrating a multiplexer according to one or more embodiments of the present disclosure;

FIG. 6 is a circuit diagram illustrating in detail one example of the pixel circuit shown in FIG. 3 according to one or more embodiments of the present disclosure;

FIGS. 7A and 7B are circuit diagrams illustrating transistors that are turned on/off depending on scan signals switched by a multiplexer in the pixel circuit shown in FIG. 6 according to one or more embodiments of the present disclosure;

FIG. 8 is a waveform diagram illustrating an example of the pixel circuit shown in FIG. 6 during one refresh frame period in a first viewing angle mode according to one or more embodiments of the present disclosure;

FIGS. 9A to 9D are circuit diagrams illustrating the operation of the pixel circuit shown in FIG. 6 in a stepwise manner during a refresh frame period in a first viewing angle mode according to one or more embodiments of the present disclosure;

FIG. 10 is a waveform diagram illustrating an example of the pixel circuit shown in FIG. 6 during one refresh frame period in a second viewing angle mode according to one or more embodiments of the present disclosure;

FIGS. 11A to 11D are circuit diagrams illustrating the operation of the pixel circuit shown in FIG. 6 in a stepwise manner during a refresh frame period in a second viewing angle mode according to one or more embodiments of the present disclosure;

FIGS. 12 to 13D are diagrams illustrating in a stepwise manner, when the pixel circuit shown in FIG. 6 is alternately driven in a first viewing angle mode and a second viewing angle mode, the operation of the pixel circuit in the first viewing angle mode according to one or more embodiments of the present disclosure;

FIGS. 14 to 15D are drawings illustrating in a stepwise manner, when the pixel circuit shown in FIG. 6 is alternately driven in a first viewing angle mode and a second viewing angle mode, the operation of the pixel circuit in the second viewing angle mode according to one or more embodiments of the present disclosure;

FIG. 16 is a circuit diagram illustrating in detail another example of the pixel circuit shown in FIG. 3 according to one or more embodiments of the present disclosure;

FIGS. 17 to 18C are diagrams illustrating in a stepwise manner, when the pixel circuit shown in FIG. 16 is alternately driven in a first viewing angle mode and a second viewing angle mode, the operation of the pixel circuit in the first viewing angle mode according to one or more embodiments of the present disclosure;

FIGS. 19 to 20C are drawings illustrating in a stepwise manner, when the pixel circuit shown in FIG. 16 is alternately driven in a first viewing angle mode and a second viewing angle mode, the operation of the pixel circuit in the second viewing angle mode according to one or more embodiments of the present disclosure; and

FIG. 21 is a circuit diagram illustrating an example of the signal transmission part shown in FIG. 5 according to one or more embodiments of the present disclosure.

### DETAILED DESCRIPTION OF THE EMBODIMENTS

The advantages and features of the present disclosure and methods for accomplishing the same will be more clearly understood from embodiments described below with reference to the accompanying drawings. However, the present disclosure is not limited to the following embodiments but can be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present disclosure. Further, in describing the present disclosure, detailed descriptions of known related technologies can be omitted to avoid unnecessarily obscuring the subject matter of the present disclosure.

The terms such as “comprising,” “including,” and “having,” used herein are generally intended to allow other components to be added unless the terms are used with the term “only.” Any references to singular can include plural unless expressly stated otherwise.

Components are interpreted to include an ordinary error range even if not expressly stated.

When a positional or interconnected relationship is described between two components, by using terms such as “on top of,” “above,” “below,” “next to,” “connect or couple with,” “crossing,” “intersecting,” or the like, one or more other components can be interposed between them, unless “immediately” or “directly” is used.

When a temporal antecedent relationship is described, by using terms such as “after”, “following”, “next to”, “before”, or the like, it may not be continuous on a time base unless “immediately” or “directly” is used.

The terms “first,” “second,” and the like can be used to distinguish components from each other, but the functions or structures of the components are not limited by ordinal numbers or component names in front of the components. Further, the term “can” fully encompasses all the meanings and coverages of the term “may” and vice versa.

The following embodiments of the present disclosure can be partially or entirely bonded to or combined with each other and can be linked and operated in technically various ways. The embodiments of the present disclosure can be carried out independently of or in association with each other.

The pixel circuit and the gate drive circuit of the display device can include a plurality of transistors. The transistor can be implemented as a thin film transistor (TFT). The transistors can be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons can flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes can flow from a source to a drain. In the p-channel transistor, since holes flow from the source to the drain, current flows from the source to the drain. It should be noted that a source and a drain of a transistor are not fixed. For example, a source and a drain can be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage can be a gate high voltage VGH, and the gate-off voltage can be a gate low voltage VGL. In the case of a p-channel transistor, the gate-on voltage can be the gate low voltage VGL, and the gate-off voltage can be the gate high voltage VGH.

Hereinafter, various embodiments of the present disclosure will be described in detail with reference to the accompanying drawings. All the components of each display device/apparatus according to all embodiments of the present disclosure are operatively coupled and configured.

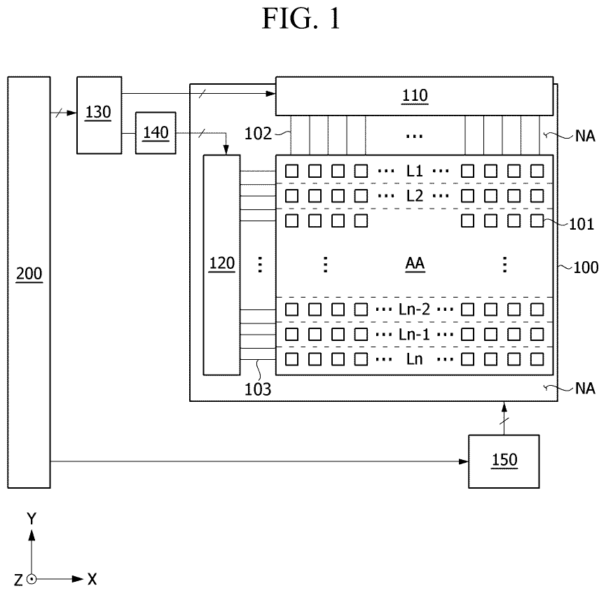

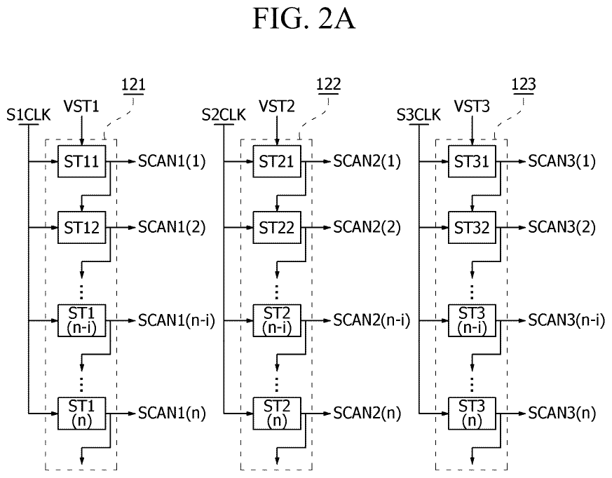

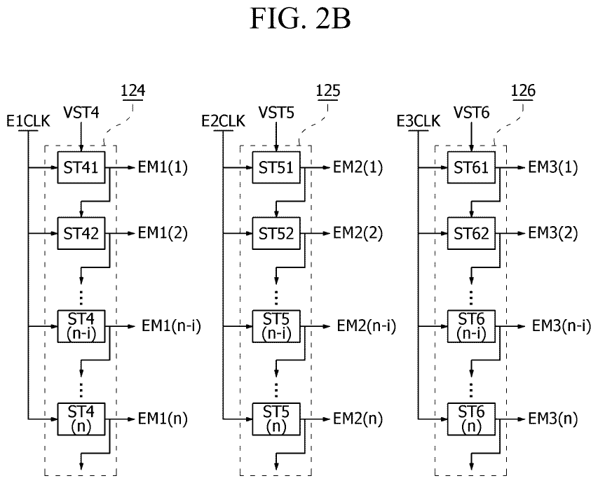

FIG. 1 is a part diagram illustrating a display device according to one or more embodiments of the present disclosure. FIGS. 2A and 2B are drawings illustrating one example of a gate driver according to one or more embodiments of the present disclosure.

Referring to FIG. 1, a display device according to an embodiment of the present disclosure includes a display panel 100 and a display panel driving circuit for writing pixel data to pixels of the display panel 100. In addition, the display device includes a power supply 150.

The display panel 100 can be, but is not limited to, a panel having a rectangular structure with a length in an X-axis direction, a width in a Y-axis direction, and a thickness in a Z-axis direction. For example, the display panel 100 can be a deformed panel that is at least partially curved or elliptical.

A display area (or active area) AA of the display panel 100 includes a pixel array for displaying an input image thereon. The pixel array includes a plurality of data lines 102, a plurality of gate lines 103 intersected with the data lines 102, and the pixels arranged in a matrix form. The display panel 100 can further include a plurality of power lines. The power lines are connected to constant voltage nodes of the pixel circuits and supply a constant voltage necessary for driving the pixels 101 to the pixels 101. The power lines can be implemented as striped or mesh wirings to be connected in common to the pixels 101 of the display panel 100.

Each of the pixels 101 can be divided into a red sub-pixel, a green sub-pixel, and a blue sub-pixel for color implementation. Each of the pixels can further include a white sub-pixel. Each of the sub-pixels can include a pixel circuit for driving first and second light-emitting elements that selectively emit light according to the selected viewing angle mode. Light-emitting elements can be a light-emitting element, such as an organic light emitting diode (OLED) or a micro light-emitting diode (LED). In the following, a pixel can be interpreted as a sub-pixel.

The display area AA includes a plurality of pixel lines L1 to Ln, where n can be a real number such as a positive integer. Each of the pixel lines L1 to Ln includes one line of pixels arranged along the X-axis direction in the pixel array of the display panel 100. The pixels 101 arranged in one pixel line can share the gate lines 103. The sub-pixels arranged along the Y-axis direction can share the same data line 102. One horizontal period is a time obtained by dividing one frame period by the total number of the pixel lines L1 to Ln.

Touch sensors can be arranged on the display panel 100 to sense touch inputs. The touch sensors can be arranged on the display panel 100 as an on-cell type or an add-on type, or implemented as in-cell type touch sensors embedded in the pixel array.

The display panel 100 can be implemented as a non-transmissive display panel or a transmissive display panel. The transmissive display panel can be employed in a transparent display device in which an image is displayed on a screen and an actual object is visible beyond the display panel. The display panel 100 can be made as a flexible display panel that can be flexibly bent.

The power supply 150 receives an input voltage from a host system 200 and output voltages required to drive the pixels 101 of the display panel 100 and the display panel driving circuit. To this end, the power supply 150 can include a direct current to direct current converter (DC-DC converter). The DC-DC converter can include a charge pump, a regulator, a buck converter, a boost converter, and the like. The power supply 150 can output constant voltages (or direct current voltages), such as a gate high voltage, a gate low voltage, a pixel driving voltage, a cathode voltage, an initialization voltage, and an IC driving voltage for the display panel driving circuit through the DC-DC converter. The gate high voltage and the gate low voltage can be supplied to a level shifter 140 and the gate driver 120. The voltages such as the pixel driving voltage, the cathode voltage, and the initialization voltage are supplied to the pixels 101 via the power lines commonly connected to the pixels 101.

The power supply 150 can further include a gamma voltage generator. The gamma voltage generator receives a high potential reference voltage and a low potential reference voltage and outputs a plurality of gamma reference voltages divided by a predetermined voltage interval on a preset gamma curve, for example, 2.2 gamma curve. The gamma reference voltages are supplied to the data driver 110. In the data driver 110, the gamma reference voltages are divided by a voltage division circuit and subdivided into grayscale voltages. The gamma voltage generator can be implemented as a programmable gamma circuit capable of adjusting each of the gamma reference voltages according to digital data. A timing controller 130 or the host system 200 or a separate external device can update digital data stored in a register of the programmable gamma circuit through a communication interface.

The display panel driving circuit writes the pixel data of the input image to the pixels 101 of the display panel 100 under the control of the timing controller 130. The display panel driving circuit includes the data driver 110 and the gate driver 120. The display panel driving circuit can further include a touch sensor driver for driving touch sensors. The touch sensor driver is omitted from FIG. 1. The data driver 110 and the touch sensor driver can be integrated into a source drive integrated circuit (IC).

The data driver 110 receives the pixel data of the input image received as a digital signal from the timing controller 130 and outputs the data voltage. The input image can be image data including various contents such as private content, shared content, and the like. The data driver 110 can receive the gamma reference voltages and generate gamma compensated voltages for each grayscale through the voltage division circuit. A gamma-compensated voltage for each grayscale is supplied to a digital to analog converter (DAC) disposed on each of the channels of the data driver 110.

The data driver 110 samples and latches the pixel data and then inputs the digital data to the DAC. The DAC converts the pixel data to the gamma compensated voltage and outputs pixel data voltage.

The gate driver 120 can be formed on the display panel 100 together with circuit elements of the display area AA and the wires. The gate driver 120 can be disposed in a non-display area (or non-active area) NA on at least one of the right and left sides outside the display area AA in the display panel 100, or at least a portion thereof can be disposed within the display area AA.

The gate driver 120 can be disposed in the non-display areas NA on both sides of the display panel 100 with the display area AA of the display panel 100 interposed therebetween, and can supply gate pulses from the both sides of the gate lines 103 in a double feeding method. In another embodiment, the gate driver 120 can be disposed in at least one of the left and right non-display areas NA of the display panel 100 to supply gate signals to the gate lines 103 in a single feeding method. The gate driver 120 sequentially outputs pulses of the gate signals to the gate lines 103 under the control of the timing controller 130. The gate driver 120 can sequentially supply the gate signals to the gate lines 103 by shifting the pulses of the gate signals using a shift register or an edge trigger.

The timing controller 130 receives digital video data of the input image and a timing signal synchronized with the digital video data from the host system 200. The timing signal can include a vertical synchronization signal (Vsync), a horizontal synchronization signal (Hsync), and a data enable signal (DE). A vertical period and a horizontal period can be known by counting the data enable signal (DE), and thus the vertical synchronization signal (Vsync) and the horizontal synchronization signal (Hsync) can be omitted. The horizontal synchronization signal (Hsync) and the data enable signal (DE) have a period of one horizontal period (1H).

The timing controller 130 generates a data timing control signal for controlling the operation timing of the data driver 110, a gate timing control signal for controlling the operation timing of the gate driver 120, and a mode selection signal to control the viewing angle mode of each of the pixels 101, based on the timing signals (e.g., Vsync, Hsync, and DE) received from the host system 200, thereby controlling the pixels 101 and the display panel driving circuit. The timing controller 130 can synchronize the data driver 110 and the gate driver 120 by controlling the operation timing of the display panel driving circuit.

A gate timing control signal output from the timing controller 130 can be inputted to the shift register of the gate driver 120 through the level shifter 140. The level shifter 140 can convert a voltage level of the gate timing signal received from the timing controller 130 to a swing width between the gate low voltage and the gate high voltage and supply it to the gate driver 120.

The host system 200 can scale an image signal from a video source to match the resolution of the display panel 100, and can transmit it to the timing controller 130 together with the timing control signal. The host system 200 can transmit a mode signal for controlling the viewing angle together with the image signal, and a flag signal indicating the presence or absence of data of personal content or private content that requires privacy protection to the timing controller 130. The timing controller 130 can control the gate signals output from the gate driver 120 in the viewing angle mode selected by a mode signal from the host system 200, and controls the data driver 110 in the selected viewing angle mode. The timing controller 130 can output a mode selection signal based on the mode signal from the host system 200.

When a plurality of gate signals are applied to each of the pixels, the gate driver 120 can include a plurality of gate drivers. The gate signals can include a first scan signal SCAN1(1) to SCAN1(n), a second scan signal SCAN2(1) to SCAN2(n), a third scan signal SCAN3(1) to SCAN3(n), a first emission signal EM1(1) to EM1(n), a second emission signal EM2(1) to EM2(n), and a third emission signal EM3(1) to EM3(n), which are inputted to the pixel circuit through a plurality of gate lines as shown in FIGS. 2A and 2B. Hereinafter, the “emission signal” is referred to as “EM signal.” In this case, the gate driver 120 can include a first gate driver 121 that outputs the first scan signal SCAN1(1) to SCAN1(n), a second gate driver 122 that outputs the second scan signal SCAN2(1) to SCAN2(n), a third gate driver 123 that outputs the third scan signal SCAN3(1) to SCAN3(n), a fourth gate driver 124 that outputs the first EM signal EM1(1) to EM1(n), a fifth gate driver 125 that outputs the second EM signal EM2(1) to EM2(n), and a sixth gate driver 126 that outputs the third EM signal EM3(1) to EM3(n). Alternatively, the third gate driver 123 and the sixth gate driver 126 can be omitted. In FIGS. 2A and 2B, the numbers in parentheses indicate pixel line numbers. For example, SCAN1(n−i), SCAN2(n−i), SCAN3(n−i), EM1(n−i), EM2(n−i), and EM3(n−i) are applied to the sub-pixels of an (n−i)^{th} pixel line. In (n−i), i is a positive integer smaller than n.

Start signals VST1 to VST6 and clock signals S1CLK to S3CLK and E1CLK to E3CLK can be inputted to the gate drivers 121 to 126. The gate drivers 121 to 126 includes a plurality of signal transmission parts ST11 to ST6(n) that are connected in a cascaded manner. The signal transmission parts ST11 to ST6(n) of the gate drivers 121 to 126 sequentially output pulses of the gate signals SCAN1(1) to SCAN1(n), SCAN2(1) to SCAN2(n), SCAN3(1) to SCAN3(n), EM1(1) to EM1(n), EM2(1) to EM2(n), and EM3(1) to EM3(n) by receiving the start signals VST1 to VST6 and the clock signals S1CLK to S3CLK and E1CLK to E3CLK. The waveforms of the gate signals SCAN1(1) to SCAN1(n), SCAN2(1) to SCAN2(n), SCAN3(1) to SCAN3(n), EM1(1) to EM1(n), EM2(1) to EM2(n), and EM3(1) to EM3(n) can vary depending on the viewing angle mode of the sub-pixels. The timing controller 130 can vary the start signals VST1 to VST6 and the clock signals S1CLK to S3CLK and E1CLK to E3CLK depending on the viewing angle mode of the sub-pixels to control the waveforms of the gate signals SCAN1(1) to SCAN1(n), SCAN2(1) to SCAN2(n), SCAN3(1) to SCAN3(n), EM1(1) to EM1(n), EM2(1) to EM2(n), and EM3(1) to EM3(n) in accordance with the selected viewing angle mode.

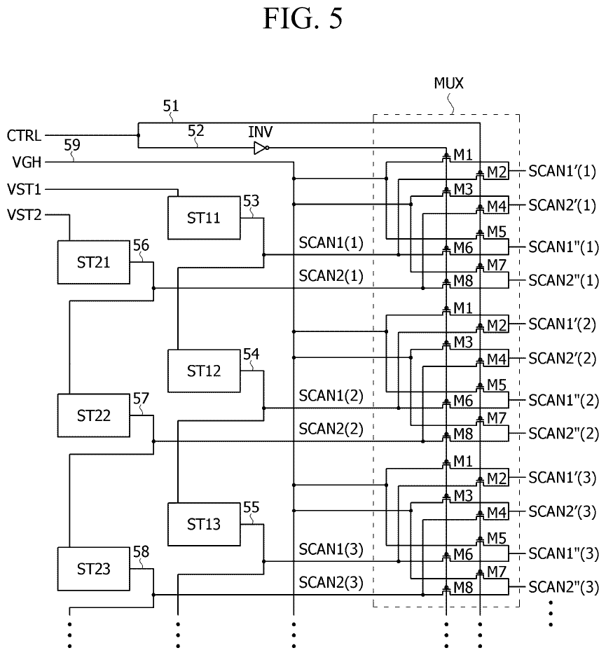

The gate driver 120 further includes a multiplexer MUX (see FIG. 5) that, under the control of the timing controller 130, selects one of the first scan signal SCAN1(1) to SCAN1(n) and the gate high voltage (or gate-off voltage) VGH according to the viewing angle mode, and selects one of the second scan signal SCAN2(1) to SCAN2(n) and the gate high voltage VGH according to the viewing angle mode. The multiplexer MUX can be located on the display panel 100 between the gate driver 120 and the pixels 101, or can be at least partially located in the display area AA.

The multiplexer MUX changes a voltage of the gate signal required for the sub-pixels with variable viewing angles in accordance with the viewing angle mode, thereby reducing the circuit size of the gate driver 120. As the circuit size of the gate driver 120 decreases, the outer non-display area NA of the display panel 100 is reduced, making it easier to implement a narrow bezel design of the display panel 100. FIG. 5 illustrates one example of the multiplexer MUX.

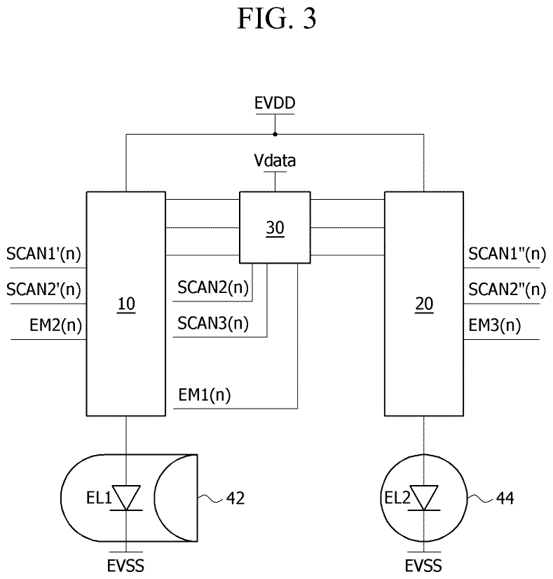

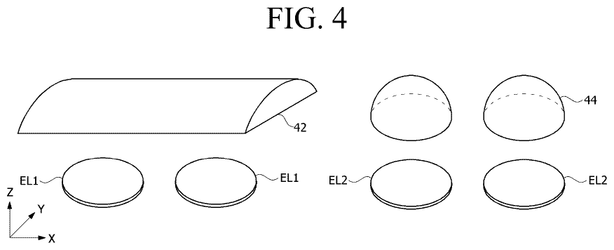

FIG. 3 is a circuit diagram illustrating a pixel circuit according to the embodiment of the present disclosure. FIG. 4 is a diagram illustrating an example of lenses provided in sub-pixels.

Referring to FIGS. 3 and 4, each of the sub-pixels of the display panel 100 includes a first light-emitting element EL1, a second light-emitting element EL2, a first driver 10, a second driver 20, and a shared switch part 30.

Each of the first and second light-emitting elements EL1 and EL2 can be a light-emitting element such as an organic light-emitting diode (OLED) or a micro light-emitting element (LED), but the present disclosure is not limited thereto. The first light-emitting element EL1 can be driven in a first viewing angle mode to emit light. When the first light-emitting element EL1 emits light, light from the first light-emitting element EL1 can be diffused via a first lens 42 and emitted with a wide viewing angle. The second light-emitting element EL2 can be driven in a second viewing angle mode to emit light. When the second light-emitting element EL2 emits light, light from the second light-emitting element EL2 can be converged via a second lens 44 and emitted with a narrow viewing angle.

The first driver 10 receives a pixel driving voltage EVDD, a first data voltage Vdata, and gate signals SCAN1′(n), SCAN2′(n), and EM2(n). The first driver 10 generates a driving current of the first light-emitting element EL1 to drive the first light-emitting element EL1. The first driver 10 can include a first capacitor and a plurality of transistors.

The second driver 20 receives the pixel driving voltage EVDD, a second data voltage Vdata, and gate signals SCAN1′'(n), SCAN2′'(n), and EM3(n). The second driver 20 generates a driving current of the second light-emitting element EL2 to drive the second light-emitting element EL2. The second driver 20 can include a second capacitor and a plurality of transistors.

The shared switch part 30 includes a plurality of transistors electrically connected to the first driver 10 and the second driver 20. The shared switch part 30 receives the data voltage Vdata and the gate signals SCAN2(n), SCAN3(n), and EM1(n), and transmits the data voltage Vdata to the first driver 10 and the second driver 20. The data voltage Vdata can be the first data voltage corresponding to pixel data inputted as a shared content signal, or the second data voltage corresponding to pixel data inputted as a personal content signal.

The first data voltage Vdata can be charged in the first capacitor, and the shared content can be reproduced as light emitted at a wide viewing angle through the first light-emitting element EL1 and the first lens 42. The second data voltage Vdata can be charged in the second capacitor, and the personal content can be reproduced as light emitted at a narrow viewing angle through the second light-emitting element EL2 and the second lens 44. The first data voltage Vdata and the second data voltage Vdata are not limited to pixel data of different content. The first data voltage Vdata and the second data voltage Vdata can be data voltages of the same pixel data. In this case, since the first and second light-emitting elements emit light based on the same data voltage, the pixel can emit light at high luminance.

The first lens 42 is a lens for a wide viewing angle provided above the first light-emitting element EL1. The first lens 42 overlaps a light emission area of the first light-emitting element EL1. The first lens 42 can be implemented by a semicylindrical lens to limit upper and lower viewing angles and widen right and left viewing angle. The first lens 42 is long in a right-left direction (or an X-axis direction) of the display panel 100 and is short in an up-down direction (or a Y-axis direction) of the display panel 100. The first lens 42 converges light of the first light-emitting element EL1 in the up-down direction and diffuses light of the first light-emitting element EL1 with a wide viewing angle in the right-left direction to make light from the first light-emitting element EL1 travel with a wide viewing angle in the right-left direction.

The second lens 44 is a lens for a narrow viewing angle provided above the second light-emitting element EL2. The second lens 44 overlaps a light emission area of the second light-emitting element EL2. The second lens 44 can be a semispherical lens that is thick in the center portion and thinner toward an edge in the up-down direction and the right-left direction. The second lens 44 converges light of the second light-emitting element EL2 to make the light emitted from the second light-emitting element EL2 travel with a narrow viewing angle in the up-down direction and the right-left direction.

The first and second lenses 42 and 44 can be implemented with a transparent medium or transparent insulation layer pattern provided in the display panel 100, but the present disclosure is not limited thereto. The first and second lenses 42 and 44 can prevent a phenomenon that light from pixels is reflected on a windshield of a vehicle and a screen of the display device is visible, by limiting upper and lower viewing angles of pixels.

The display panel driving circuit can be driven at a variable refresh rate (VRR) under the control of the timing controller 130 or the host system 200. For example, the timing controller 130 can reduce the power consumption of the display device by analyzing the input video and lowering the refresh rate when the input video has not change for a preset time. For example, the display panel driving circuit can reduce the power consumption of the display device by controlling a data writing period to be long by lowering the refresh rate of the pixels 101 when a still image is input for a given time or more under the control of the timing controller 130. The display device can operate in a standby mode or the driving circuit of the display panel 100 can lower the refresh rate in response to a user's command. The refresh rate can be lowered on an always on display (AOD) screen. The AOD screen is a partial pixel area of the display area AA on which preset information, for example, brief information such as a state of charge of a battery and time is displayed in the standby mode.

The timing controller 130 or the host system 200 can control the display panel driving circuit to adjust the viewing angle of the pixel to a first viewing angle during a first frame period. The timing controller 130 or the host system 200 can control the display panel driving circuit to adjust the viewing angle of the pixel to a second viewing angle during a second frame period. The timing controller 130 or the host system 200 can change the viewing angle of each pixel using a variable refresh rate. The refresh rate can be a frequency of a refresh frame in which data is written to the pixels. When pixel data of a general image is written to the pixels, the pixel data can be written to the pixels at a refresh rate of 60 Hz or 120 Hz or higher. When the above-described low-speed driving event occurs, the display panel driving circuit can enter a low-speed driving mode, and the pixel data can be written to the pixels at a refresh rate lower than 60 Hz, e.g., at a frequency of 1 Hz to 10 Hz. When the refresh rate is 120 Hz, the pixel data can be written to the pixels in 120 refresh frame periods per second. A skip frame period or an extended blank period, during which the pixel data is not written after the refresh frame period and the data voltage charged during the previous refresh frame period is maintained, can become longer.

FIG. 5 is a circuit diagram illustrating a multiplexer according to one embodiment of the present disclosure.

Referring to FIGS. 2A, 3, and 5, to the input terminals of the multiplexer MUX, the signal transmission parts ST11, ST12, and ST13 of the first gate driver 121 that sequentially output the first scan signals SCAN1(1) to SCAN1(n) and the signal transmission parts ST21, ST22, and ST23 of the second gate driver 122 that sequentially output the second scan signals SCAN2(1) to SCAN2(n) are connected, and the gate high voltage VGH is inputted. The gate high voltage VGH can be interpreted as the gate-off voltage. The scan signals SCAN1′(1) to SCAN2″(3) that are provided to the first driver 10 and the second driver 20 can be outputted through the output terminals of the multiplexer MUX.

The multiplexer MUX includes a plurality of transistors M1 to M8. The transistors M1 to M8 can be p-channel transistors, but are not limited thereto. The timing controller 130 can control the multiplexer MUX. A MUX control signal CTRL generated from the timing controller 130 is inputted to control nodes of the multiplexer MUX through the level shifter 140. The control nodes of the multiplexer MUX are connected to the gate electrodes of the transistors constituting the multiplexer MUX. The MUX control signal CTRL is applied to the gate electrodes of second, fourth, fifth, and seventh transistors M2, M4, M5, and M7 through a first CTRL node 51 to control the on/off states of the transistors M2, M4, M5, and M7. The MUX control signal CTRL is inverted by an inverter INV and applied to the gate electrodes of first, third, sixth, and eighth transistors M1, M3, M6, and M8 through a second CTRL node 52 to control the on/off states of the transistors M1, M3, M6, and M8. The transistors M2, M4, M5, and M7 to which the non-inverted MUX control signal CTRL is applied and the transistors M1, M3, M6, and M8 to which the inverted MUX control signal CTRL is applied are turned on/off in opposite manners. For example, in the first viewing angle mode, the transistors M2, M4, M5, and M7 are turned on, whereas the transistors M1, M3, M6, and M8 are turned off. In the second viewing angle mode, the transistors M1, M3, M6, and M8 are turned on, whereas the transistors M2, M4, M5, and M7 are turned off.

The first transistor M1 is connected between a VGH node 59 and a corresponding output node, and is turned off in the first viewing angle mode and turned on in the second viewing angle mode in response to the inverted MUX control signal CTRL. When the first transistor M1 is turned on, the gate high voltage VGH is applied to the first driver 10 as the voltage of first-first scan signals SCAN1′(1), SCAN1′(2), and SCAN1′(3). The third transistor M3 is connected between the VGH node 59 and a corresponding output node, and is turned off in the first viewing angle mode and turned on in the second viewing angle mode in response to the inverted MUX control signal CTRL. When the third transistor M3 is turned on, the gate high voltage VGH is applied to the first driver 10 as the voltage of second-first scan signals SCAN2′(1), SCAN2′(2), and SCAN2′(3).

The second transistor M2 is connected between output nodes 53, 54, and 55 of the signal transmission parts ST11, ST12, and ST13, which output the first scan signals SCAN1(1), SCAN1(2), and SCAN1(3), and corresponding output nodes, and is turned on in the first viewing angle mode and turned off in the second viewing angle mode in response to the MUX control signal CTRL. When the second transistor M2 is turned on, the first scan signals SCAN1(1), SCAN1(2), and SCAN1(3) outputted from the signal transmission parts ST11, ST12, and ST13 are applied to the first driver 10 as the first-first scan signals SCAN1′(1), SCAN1′(2), and SCAN1′(3). The fourth transistor M4 is connected between output nodes 56, 57, and 58 of the signal transmission parts ST21, ST22, and ST23, which output the second scan signals SCAN2(1), SCAN2(2), and SCAN2(3), and corresponding output nodes, and is turned on in the first viewing angle mode and turned off in the second viewing angle mode in response to the MUX control signal CTRL. When the fourth transistor M4 is turned on, the second scan signals SCAN2(1), SCAN2(2), and SCAN2(3) outputted from the signal transmission parts ST21, ST22, and ST23 are applied to the first driver 10 as the second-first scan signals SCAN2′(1), SCAN2′(2), and SCAN2′(3).

The fifth transistor M5 is connected between the VGH node 59 and a corresponding output node, and is turned on in the first viewing angle mode and turned off in the second viewing angle mode in response to the MUX control signal CTRL. When the fifth transistor M5 is turned on, the gate high voltage VGH is applied to the second driver 20 as the voltage of first-second scan signals SCAN1″(1), SCAN1″(2), and SCAN1″(3). The seventh transistor M7 is connected between the VGH node 59 and a corresponding output node, and is turned on in the first viewing angle mode and turned off in the second viewing angle mode in response to the MUX control signal CTRL. When the seventh transistor M7 is turned on, the gate high voltage VGH is applied to the second driver 20 as the voltage of second-second scan signals SCAN2″(1), SCAN2″(2), and SCAN2″(3).

The sixth transistor M6 is connected between the output nodes 53, 54, and 55 of the signal transmission parts ST11, ST12, and ST13, which output the first scan signals SCAN1(1), SCAN1(2), and SCAN1(3), and corresponding output nodes, and is turned off in the first viewing angle mode and turned on in the second viewing angle mode in response to the inverted MUX control signal CTRL. When the sixth transistor M6 is turned on, the first scan signals SCAN1(1), SCAN1(2), and SCAN1(3) outputted from the signal transmission parts ST11, ST12, and ST13 are applied to the second driver 20 as the first-second scan signals SCAN1″(1), SCAN1″(2), and SCAN1″(3). The eighth transistor M8 is connected between the output nodes 56, 57, and 58 of the signal transmission parts ST21, ST22, and ST23, which output the second scan signals SCAN2(1), SCAN2(2), and SCAN2(3), and corresponding output nodes, and is turned off in the first viewing angle mode and turned on in the second viewing angle mode in response to the inverted MUX control signal CTRL. When the eighth transistor M8 is turned on, the second scan signals SCAN2(1), SCAN2(2), and SCAN2(3) outputted from the signal transmission parts ST21, ST22, and ST23 are applied to the second driver 20 as the second-second scan signals SCAN2″(1), SCAN2″(2), and SCAN2″(3).

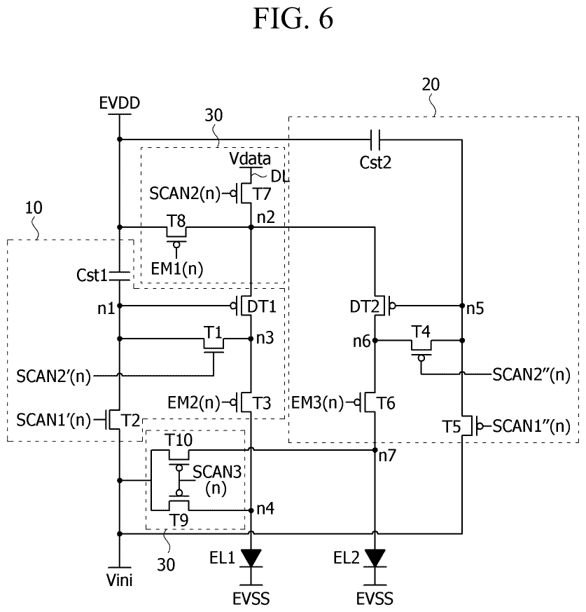

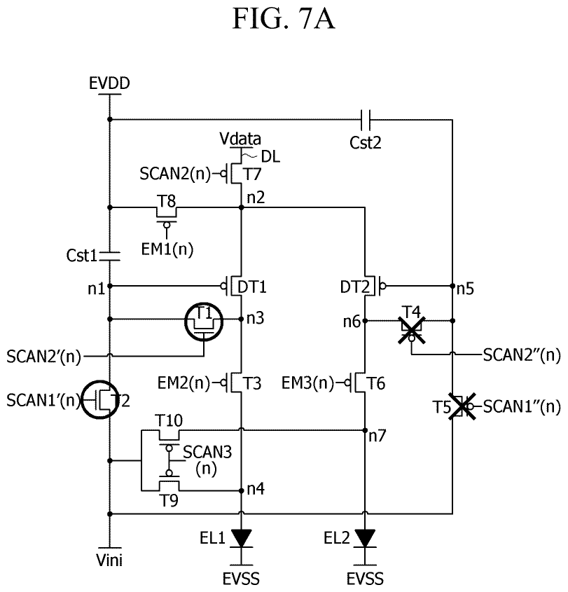

FIG. 6 is a circuit diagram illustrating in detail one example of the pixel circuit shown in FIG. 3. The pixel circuit shown in FIG. 6 can be a pixel circuit of a sub-pixel located on an n^{th} (where n is a natural number) pixel line.

Referring to FIG. 6, the pixel circuit includes a plurality of transistors DT1, DT2, and T1 to T10, a first capacitor Cst1, and a second capacitor Cst2. The transistors DT1, DT2, and T1 to T10 can be implemented as p-channel LTPS transistors, but are not limited thereto.

The pixel circuit is connected to a data line DL to which the data voltage Vdata is applied, and the gate lines to which the gate signals SCAN1′(n), SCAN2′(n), SCAN1″(n), SCAN2″(n), SCAN2(n), SCAN3(n), EM1(n), EM2(n), and EM3(n) are applied.

The pixel circuit can be connected to power nodes to which constant voltages are applied, including a first constant voltage node to which the pixel driving voltage EVDD is applied, a second constant voltage node to which a cathode voltage EVSS is applied, and a third constant voltage node to which an initialization voltage Vini is applied. The cathode voltage EVSS can be a pixel ground voltage. On the display panel 100, the constant voltage nodes are connected to the power lines. The power lines can be commonly connected to all the pixels.

The pixel driving voltage EVDD and the cathode voltage EVSS can be set to voltages that allow driving transistors DT1 and DT2 to operate in a saturation region. The pixel driving voltage EVDD can be set to a voltage in the range of 2 V to 4 V, and the cathode voltage EVSS can be set to a voltage in the range of −9 V to −7 V, but are not limited thereto.

The initialization voltage Vini can be set to a voltage lower than the lower limit of the data voltage Vdata and higher than the cathode voltage EVSS, but is not limited thereto. For example, the data voltage Vdata can have a dynamic range of 2 V to 6 V. Within this dynamic range, the voltage level of the data voltage Vdata can be selected according to the grayscale value of the pixel data. In this case, the initialization voltage Vini can be set to a voltage in the range of −6 V to −3 V, but is not limited thereto.

The gate signals SCAN1′(n), SCAN2′(n), SCAN1″(n), SCAN2″(n), SCAN2(n), SCAN3(n), EM1(n), EM2(n), and EM3(n) can include pulses that swing between the gate high voltage VGH and the gate low voltage VGL. Hereinafter, the gate high voltage VGH is referred to as the gate-off voltage VGH, and the gate low voltage VGL is referred to as the gate-on voltage VGL. The gate-off voltage VGH of the gate signals SCAN1′(n), SCAN2′(n), SCAN1″(n), SCAN2″(n), SCAN2(n), SCAN3(n), EM1(n), EM2(n), and EM3(n) can be set to a voltage higher than the pixel driving voltage EVDD, and the gate-on voltage VGL can be set to a voltage lower than the cathode voltage EVSS. For example, the gate-off voltage VGH can be set to a voltage in the range of 5 V to 10 V, and the gate-on voltage VGL can be set to a voltage in the range of −18 V to −10 V.

The first driver 10 includes a first driving transistor DT1, a first switch transistor T1, a second switch transistor T2, a third switch transistor T3, and the first capacitor Cst1.

The first driving transistor DT1 drives the first light-emitting element EL1 by generating a current according to a gate-to-source voltage charged in the first capacitor Cst1. The first driving transistor DT1 includes a gate electrode connected to a first node n1, a first electrode connected to a second node n2, and a second electrode connected to a third node n3. The first capacitor Cst1 is connected between the first constant voltage node to which the pixel driving voltage EVDD is applied and the first node n1.

The first light-emitting element EL1 can be driven by a current from the first driving transistor DT1 to emit light. The anode electrode of the first light-emitting element EL1 is connected to a fourth node n4, and the cathode electrode thereof is connected to the second constant voltage node to which the cathode voltage EVSS is applied.

The first switch transistor T1 is connected between the first node n1 and the third node n3. The first switch transistor T1 can be turned on in response to the gate-on voltage VGL of the second-first scan signal SCAN2′(n), and turned off in response to the gate-off voltage VGH. When the first switch transistor T1 is turned on, the first node n1 is electrically connected to the third node n3. The first switch transistor T1 includes a gate electrode connected to a second gate line to which the second-first scan signal SCAN2′(n) is applied, a first electrode connected to the first node n1, and a second electrode connected to the third node n3.

The second switch transistor T2 is connected between the first node n1 and the third constant voltage node to which the initialization voltage Vini is applied. The second switch transistor T2 can be turned on in response to the gate-on voltage VGL of the first-first scan signal SCAN1′(n) and turned off in response to the gate-off voltage VGH. When the second switch transistor T2 is turned on, the initialization voltage Vini is applied to the first node n1. The second switch transistor T2 includes a gate electrode connected to a first gate line to which the first-first scan signal SCAN1′(n) is applied, a first electrode connected to the first node n1, and a second electrode to which the initialization voltage Vini is applied.

The third switch transistor T3 is connected between the third node n3 and the fourth node n4. The third switch transistor T3 can be turned on in response to the gate-on voltage VGL of the second EM signal EM2(n), and turned off in response to the gate-off voltage VGH. When the third switch transistor T3 is turned on, the third node n3 can be electrically connected to the fourth node n4. The third switch transistor T3 includes a gate electrode connected to an eighth gate line to which the second EM signal EM2(n) is applied, a first electrode connected to the third node n3, and a second electrode connected to the fourth node n4.

The second driver 20 includes a second driving transistor DT2, a fourth switch transistor T4, a fifth switch transistor T5, a sixth switch transistor T6, and the second capacitor Cst2.

The second driving transistor DT2 drives the second light-emitting element EL2 by generating a current according to a gate-to-source voltage charged in the second capacitor Cst2. The second driving transistor DT2 includes a gate electrode connected to a fifth node n5, a first electrode connected to the second node n2, and a second electrode connected to a sixth node n6. The second capacitor Cst2 is connected between the first constant voltage node to which the pixel driving voltage EVDD is applied and the fifth node n5.

The second light-emitting element EL2 can be driven by a current from the second driving transistor DT2 to emit light. The anode electrode of the second light-emitting element EL2 is connected to a seventh node n7, and the cathode electrode thereof is connected to the second constant voltage node to which the cathode voltage EVSS is applied.

The fourth switch transistor T4 is connected between the fifth node n5 and the sixth node n6. The fourth switch transistor T4 can be turned on in response to the gate-on voltage VGL of the second-second scan signal SCAN2″(n) and turned off in response to the gate-off voltage VGH. When the fourth switch transistor T4 is turned on, the fifth node n5 is electrically connected to the sixth node n6. The fourth switch transistor T4 includes a gate electrode connected to a fourth gate line to which the second-second scan signal SCAN2″(n) is applied, a first electrode connected to the fifth node n5, and a second electrode connected to the sixth node n6.

The fifth switch transistor T5 is connected between the fifth node n5 and the third constant voltage node to which the initialization voltage Vini is applied. The fifth switch transistor T5 can be turned on in response to the gate-on voltage VGL of the first-second scan signal SCAN1″(n) and turned off in response to the gate-off voltage VGH. When the fifth switch transistor T5 is turned on, the initialization voltage Vini is applied to the fifth node n5. The fifth switch transistor T5 includes a gate electrode connected to a third gate line to which the first-second scan signal SCAN1″(n) is applied, a first electrode connected to the fifth node n5, and a second electrode connected to the third constant voltage node to which the initialization voltage Vini is applied.

The sixth switch transistor T6 is connected between the sixth node n6 and the seventh node n7. The sixth switch transistor T6 can be turned on in response to the gate-on voltage VGL of the third EM signal EM3(n) and turned off in response to the gate-off voltage VGH. When the sixth switch transistor T6 is turned on, the sixth node n6 can be electrically connected to the seventh node n7. The sixth switch transistor T6 includes a gate electrode connected to a ninth gate line to which the third EM signal EM3(n) is applied, a first electrode connected to the sixth node n6, and a second electrode connected to the seventh node n7.

The shared switch part 30 includes a seventh switch transistor T7, an eighth switch transistor T8, a ninth switch transistor T9, and a tenth switch transistor T10.

The seventh switch transistor T7 is connected between the data line DL, to which the data voltage Vdata is applied, and the second node n2. The seventh switch transistor T7 can be turned on in response to the gate-on voltage VGL of the second scan signal SCAN2(n) and turned off in response to the gate-off voltage VGH. When the seventh switch transistor T7 is turned on, the data line DL to which the data voltage Vdata is applied is electrically connected to the second node n2, and the data voltage Vdata is applied to the second node n2. The seventh switch transistor T7 includes a gate electrode connected to a fifth gate line to which the second scan signal SCAN2(n) is applied, a first electrode connected to the data line DL, and a second electrode connected to the second node n2.

The output nodes 56, 57, and 58 of the signal transmission parts ST21, ST22, and ST23 shown in FIGS. 2A and 5 are connected to the fifth gate line. Accordingly, the second scan signal SCAN2(n) outputted from the second gate driver 122 is applied directly to the gate electrode of the seventh switch transistor T7 without passing through the multiplexer MUX.

The eighth switch transistor T8 is connected between the first constant voltage node to which the pixel driving voltage EVDD is applied and the second node n2. The eighth switch transistor T8 can be turned on in response to the gate-on voltage VGL of the first EM signal EM1(n) and turned off in response to the gate-off voltage VGH. When the eighth switch transistor T8 is turned on, the pixel driving voltage EVDD is applied to the second node n2. The eighth switch transistor T8 includes a gate electrode connected to a seventh gate line to which the first EM signal EM1(n) is applied, a first electrode connected to the first constant voltage node, and a second electrode connected to the second node n2.

The ninth switch transistor T9 is connected between the third constant voltage node to which the initialization voltage Vini is applied and the fourth node n4. The ninth switch transistor T9 can be turned on in response to the gate-on voltage VGL of the third scan signal SCAN3(n) and turned off in response to the gate-off voltage VGH. When the ninth switch transistor T9 is turned on, the initialization voltage Vini is applied to the fourth node n4. The ninth switch transistor T9 includes a gate electrode connected to a sixth gate line to which the third scan signal SCAN3(n) is applied, a first electrode connected to the third constant voltage node, and a second electrode connected to the fourth node n4.

The tenth switch transistor T10 is connected between the third constant voltage node and the seventh node n7. The tenth switch transistor T10 can be turned on in response to the gate-on voltage VGL of the third scan signal SCAN3(n) and turned off in response to the gate-off voltage VGH. When the tenth switch transistor T10 is turned on, the initialization voltage Vini is applied to the seventh node n7. The tenth switch transistor T10 includes a gate electrode connected to the sixth gate line to which the third scan signal SCAN3(n) is applied, a first electrode connected to the third constant voltage node, and a second electrode connected to the seventh node n7.

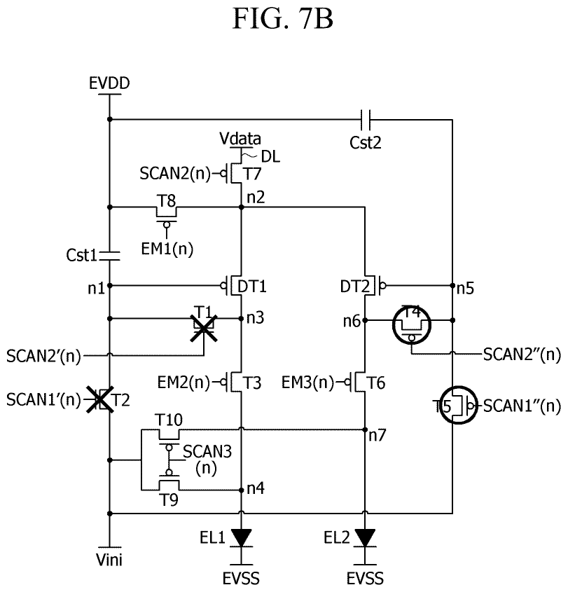

FIGS. 7A and 7B are circuit diagrams illustrating transistors that are turned on/off depending on scan signals switched by a multiplexer in the pixel circuit shown in FIG. 6.

Referring to FIGS. 5, 7A, and 7B, when the MUX control signal CTRL is generated as the gate-on voltage VGL in the first viewing angle mode, the transistors M2, M4, M5, and M7 are turned on, while the transistors M1, M3, M6, and M8 are turned off. As a result, in the first viewing angle mode, the first and second switch transistors T1 and T2 are turned on in response to the gate-on voltages VGL of the corresponding scan signals SCAN2′(n) and SCAN1′(n), while the fourth and fifth switch transistors T4 and T5 are turned off in response to the gate-off voltage VGH.

When the MUX control signal CTRL is generated as the gate-off voltage VGH in the second viewing angle mode, the transistors M1, M3, M6, and M8 are turned on, while the transistors M2, M4, M5, and M7 are turned off. As a result, in the second viewing angle mode, the first and second switch transistors T1 and T2 are turned off in response to the gate-off voltage VGH, while the fourth and fifth switch transistors T4 and T5 are turned on in response to the gate-on voltages VGL of the corresponding scan signals SCAN2″(n) and SCAN1″(n).

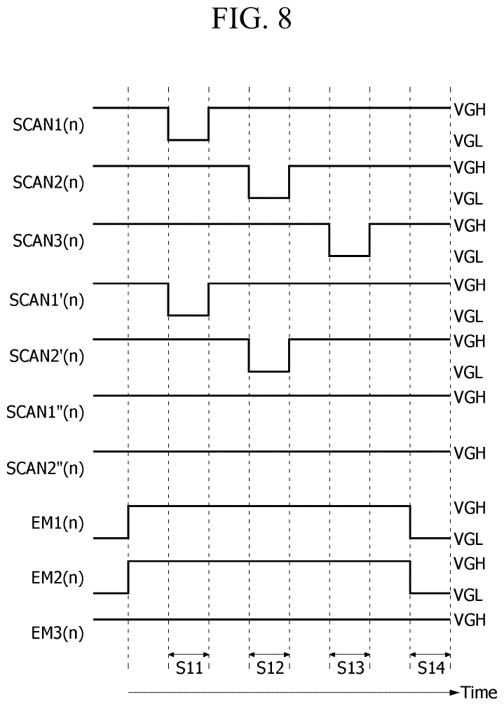

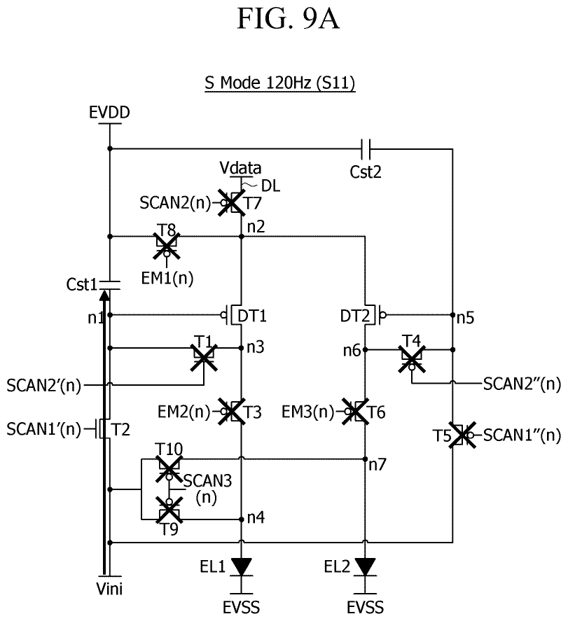

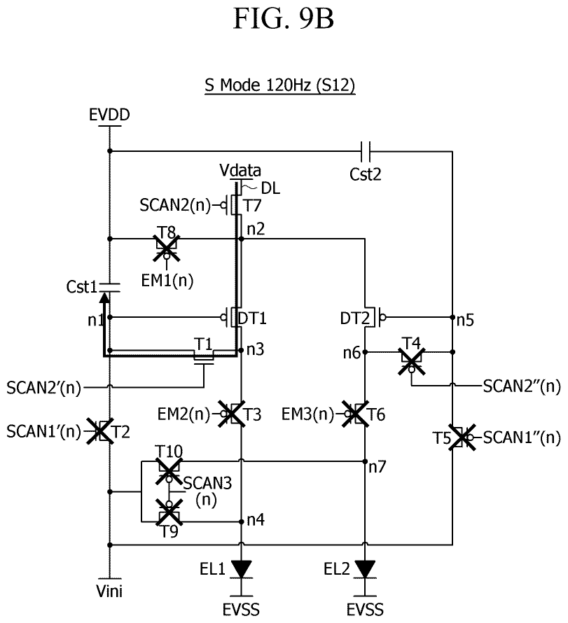

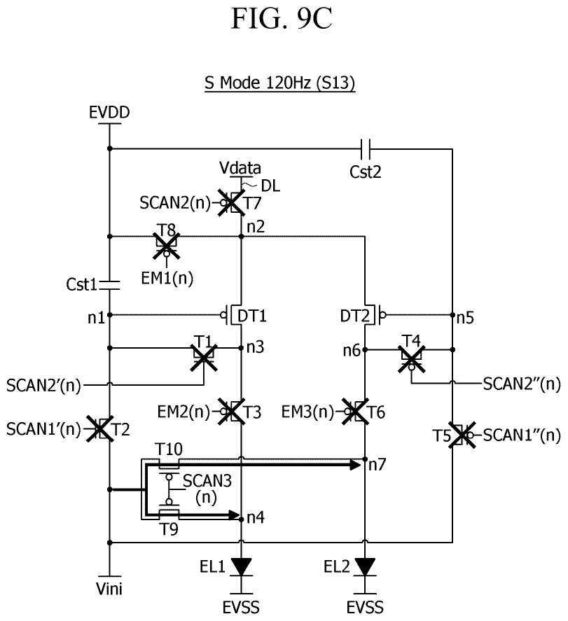

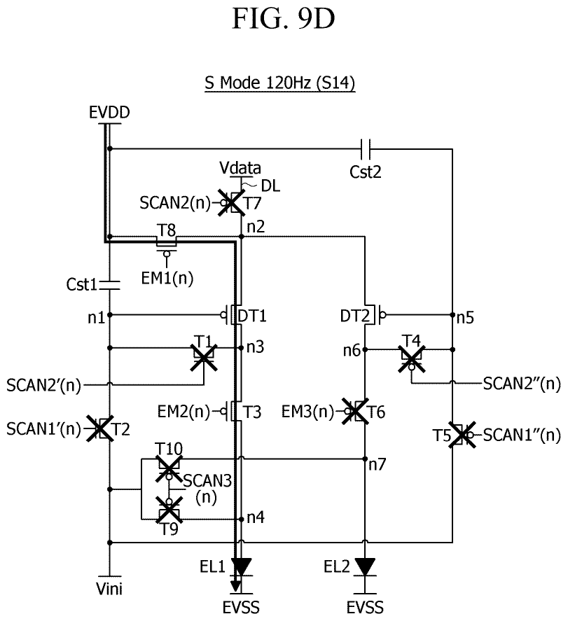

FIG. 8 is a waveform diagram illustrating an example of the pixel circuit shown in FIG. 6 during a refresh frame period in a first viewing angle mode. FIGS. 9A to 9D are circuit diagrams illustrating the operation of the pixel circuit shown in FIG. 6 in a stepwise manner during a refresh frame period in a first viewing angle mode. In FIGS. 9A to 9D, an ‘X’ indicates a transistor in the off state, and arrows indicate current paths.

Referring to FIGS. 8 to 9D, the pixel circuit can be driven at 120 Hz in a first viewing angle mode (S Mode). One refresh frame period can include a first period S11, a second period S12, a third period S13, and a fourth period S14. During the refresh frame period in the first viewing angle mode (S Mode), the first-first and second-first scan signals SCAN1′(n) and SCAN2′(n) include pulses of the gate-on voltage VGL, while the voltages of the first-second and second-second scan signals SCAN1″(n) and SCAN2″(n) are maintained at the gate-off voltage VGH. Accordingly, during the refresh frame period in the first viewing angle mode (S Mode), the first or second switch transistor T1 or T2 is turned on in response to the gate-on voltages VGL of the corresponding scan signal SCAN2′(n) or SCAN1′(n), and the data voltage Vdata can be charged in the first capacitor Cst1. In contrast, during the refresh frame period in the first viewing angle mode (S Mode), the fourth and fifth switch transistors T4 and T5 remain in the off state, and the data voltage Vdata is not charged in the second capacitor Cst2. During the refresh frame period in the first viewing angle mode (S Mode), the voltage of the second capacitor Cst2 can be maintained at the data voltage charged in the previous refresh frame period.

During the first period S11, the voltages of the first scan signal SCAN1(n) and the first-first scan signal SCAN1′(n) are at the gate-on voltage VGL, and the voltages of the other gate signals SCAN2(n), SCAN3(n), SCAN2′(n), SCAN1″(n), SCAN2″(n), EM1(n), EM2(n), and EM3(n) are at the gate-off voltage VGH. Accordingly, during the first period S11, as shown in FIG. 9A, the second switch transistor T2 is turned on, and the initialization voltage Vini is applied to the first node n1. The light-emitting elements EL1 and EL2 remain in the off state during the first period S11, and therefore do not emit light.

During the second period S12, the voltages of the second scan signal SCAN2(n) and the second-first scan signal SCAN2′(n) are generated as pulses of the gate-on voltage VGL synchronized with the first data voltage Vdata, and the voltages of the other gate signals SCAN1(n), SCAN3(n), SCAN1′(n), SCAN1″(n), SCAN2″(n), EM1(n), EM2(n), and EM3(n) are at the gate-off voltage VGH. During the second period S12, as shown in FIG. 9B, when the first and seventh switch transistors T1 and T7 are turned on in response to the gate-on voltage VGL of the corresponding scan signals SCAN2′(n) and SCAN2(n), the first data voltage Vdata is applied to the second node n2, and is also applied to the first and third nodes n1 and n3 through the first driving transistor DT1, which is in the on state. At the end of the second period S12, the voltage of the second node n2 is the data voltage Vdata, and the voltage of each of the first and third nodes n1 and n3 are equal to a voltage obtained by adding a threshold voltage Vth of the first driving transistor DT1 to the data voltage Vdata. During the second period S12, the fourth and seventh nodes n4 and n7 are in a floating state, and the light-emitting elements EL1 and EL2 remain in the off state and thus do not emit light.

During the third period S13, the voltage of the third scan signal SCAN3(n) is at the gate-on voltage VGL, and the voltages of the other gate signals SCAN1(n), SCAN2(n), SCAN1′(n), SCAN2′(n), SCAN1″(n), SCAN2″(n), EM1(n), EM2(n), and EM3(n) are at the gate-off voltage VGH. Accordingly, during the third period S13, as shown in FIG. 9C, the ninth and tenth switch transistors T9 and T10 are turned on, and the initialization voltage Vini is applied to the fourth and seventh nodes n4 and n7, so that the anode voltages of the first and second light-emitting elements EL1 and EL2 are reset to the initialization voltage Vini. During the third period S13, since the light-emitting elements EL1 and EL2 are in the off state, they do not emit light.

During the fourth period S14, the voltages of the first and second EM signals EM1(n) and EM2(n) are at the gate-on voltage VGL, and the voltages of the other gate signals SCAN1(n), SCAN2(n), SCAN3(n), SCAN1′(n), SCAN2′(n), SCAN1″(n), SCAN2″(n), and EM3(n) are at the gate-off voltage VGH. During the fourth period S14, as shown in FIG. 9D, the third and eighth switch transistors T3 and T8 can be turned on to form a current path between the pixel driving voltage EVDD and the first light-emitting element EL1, so that the first light-emitting element EL1 can emit light. In this case, the first light-emitting element EL1 can emit light at a luminance corresponding to the grayscale value of a first pixel data, by a current generated in accordance with the gate-to-source voltage of the first driving transistor DT1 that is charged in the first capacitor Cst1.

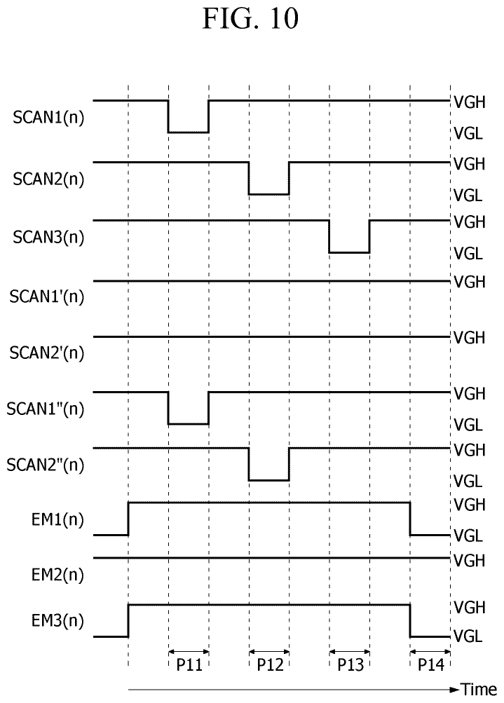

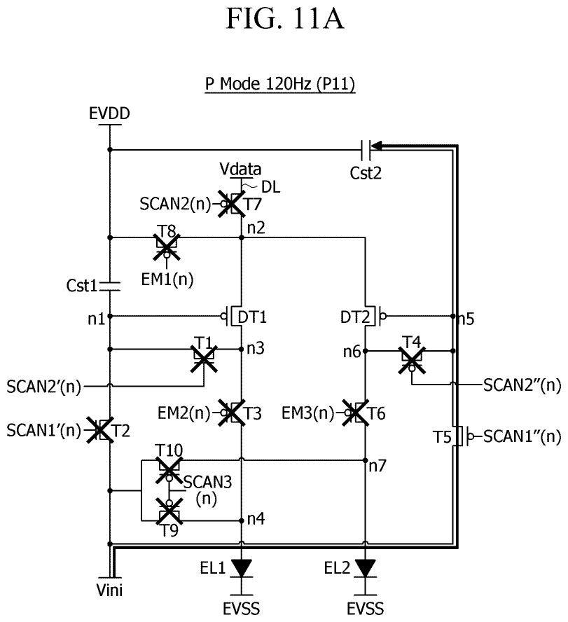

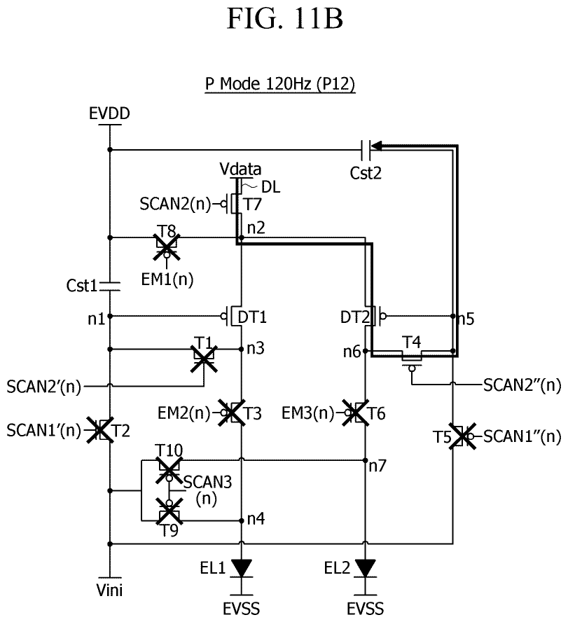

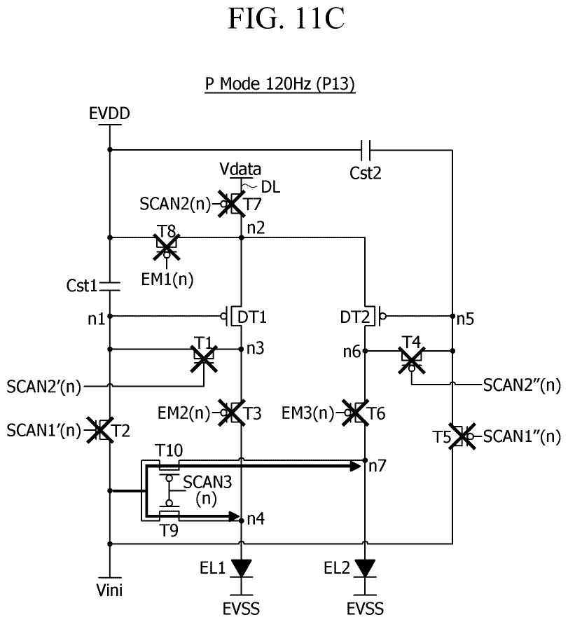

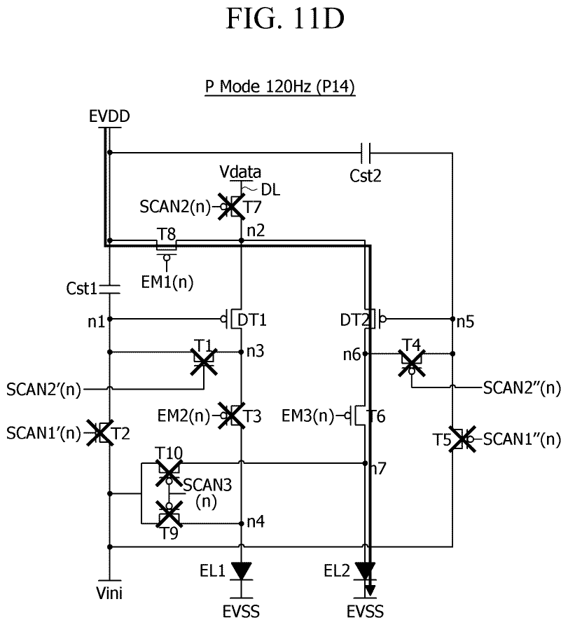

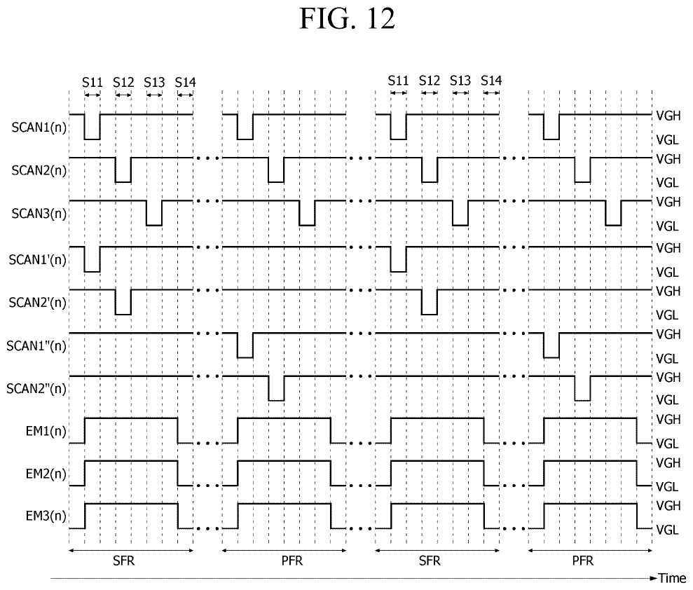

FIG. 10 is a waveform diagram illustrating an example of the pixel circuit shown in FIG. 6 during a refresh frame period in a second viewing angle mode. FIGS. 11A to 11D are circuit diagrams illustrating the operation of the pixel circuit shown in FIG. 6 in a stepwise manner during a refresh frame period in a second viewing angle mode.

Referring to FIGS. 10 to 11D, the pixel circuit can be driven at 120 Hz in a second viewing angle mode (P Mode). One refresh frame period can include a first period P11, a second period P12, a third period P13, and a fourth period P14. During the refresh frame period in the second viewing angle mode (P Mode), the first-second and second-second scan signals SCAN1″(n) and SCAN2″(n) include pulses at the gate-on voltage VGL, and the voltages of the first-first and second-first scan signals SCAN1′(n) and SCAN2′(n) are maintained at the gate-off voltage VGH. Accordingly, during the refresh frame period in the second viewing angle mode (P Mode), the fourth or fifth switch transistor T4 or T5 is turned on in response to the gate-on voltages VGL of the corresponding scan signal SCAN2″(n) or SCAN1″(n), so that the data voltage Vdata can be charged in the second capacitor Cst2. In contrast, during the refresh frame period in the second viewing angle mode (P Mode), the first and second switch transistors T1 and T2 remain in the off state, and the data voltage Vdata is not charged in the first capacitor Cst1. During the refresh frame period in the second viewing angle mode (P Mode), the voltage of the first capacitor Cst1 can be maintained at the data voltage charged in the previous refresh frame period.

During the first period P11, the voltages of the first scan signal SCAN1(n) and the first-second scan signal SCAN1″(n) are at the gate-on voltage VGL, while the voltages of the other gate signals SCAN2(n), SCAN3(n), SCAN1′(n), SCAN2′(n), SCAN2″(n), EM1(n), EM2(n), and EM3(n) are at the gate-off voltage VGH. Accordingly, during the first period P11, as shown in FIG. 11A, the fifth switch transistor T5 is turned on and the initialization voltage Vini is applied to the fifth node n5. The light-emitting elements EL1 and EL2 remain in the off state during the first period P11 and thus do not emit light.

During the second period P12, the voltages of the second scan signal SCAN2(n) and the second-second scan signal SCAN2″(n) are generated as pulses of the gate-on voltage VGL synchronized with the second data voltage Vdata, and the voltages of the other gate signals SCAN1(n), SCAN3(n), SCAN1′(n), SCAN2′(n), SCAN1″(n), EM1(n), EM2(n), and EM3(n) are at the gate-off voltage VGH. During the second period P12, as shown in FIG. 11B, when the fourth and seventh switch transistors T4 and T7 turn on in response to the gate-on voltages VGL of the corresponding scan signals SCAN2″(n) and SCAN2(n), the second data voltage Vdata is applied to the second node n2, and is also applied to the fifth and sixth nodes n5 and n6 through the second driving transistor DT2, which is in the on state. At the end of the second period P12, the voltage of the second node n2 is the data voltage Vdata, and the voltage of each of the fifth and sixth nodes n5 and n6 is equal to a voltage obtained by adding a threshold voltage Vth of the second driving transistor DT2 to the data voltage Vdata. During the second period P12, the fourth and seventh nodes n4 and n7 are in a floating state, and the light-emitting elements EL1 and EL2 are in the off state and thus do not emit light.

During the third period P13, the voltage of the third scan signal SCAN3(n) is at the gate-on voltage VGL, and the voltages of the other gate signals SCAN1(n), SCAN2(n), SCAN1′(n), SCAN2′(n), SCAN1″(n), SCAN2″(n), EM1(n), EM2(n), and EM3(n) are at the gate-off voltage VGH. Accordingly, during the third period S13, as shown in FIG. 11C, the ninth and tenth switch transistors T9 and T10 are turned on, and the initialization voltage Vini is applied to the fourth and seventh nodes n4 and n7, so that the anode voltages of the first and second light-emitting elements EL1 and EL2 are reset to the initialization voltage Vini. During the third period P13, the light-emitting elements EL1 and EL2 are in the off state, and thus do not emit light.

During the fourth period P14, the voltages of the first and third EM signals EM1(n) and EM3(n) are at the gate-on voltage VGL, and the voltages of the other gate signals SCAN1(n), SCAN2(n), SCAN3(n), SCAN1′(n), SCAN2′(n), SCAN1″(n), SCAN2″(n),and EM2(n) are at the gate-off voltage VGH. During the fourth period P14, as shown in FIG. 11D, the sixth and eighth switch transistors T6 and T8 can be turned on to form a current path between the pixel driving voltage EVDD and the second light-emitting element EL2, so that the second light-emitting element EL2 can emit light. In this case, the second light-emitting element EL2 can emit light at a luminance corresponding to the grayscale value of a second pixel data, by a current generated according to the gate-to-source voltage of the second driving transistor DT2 that is charged in the second capacitor Cst2.

In each sub-pixel, the light-emitting elements EL1 and EL2 can emit light during the fourth periods S14 and P14 in every frame period. Currents flowing through the light-emitting elements EL1 and EL2 is generated according to the gate-to-source voltages compensated by the threshold voltages of the driving transistors DT1 and DT2. A current flowing through the first light-emitting element EL1 is generated according to the gate-to-source voltage of the first driving transistor DT1 charged in the first capacitor Cst1, and a current flowing through the second light-emitting element EL2 is generated according to the gate-to-source voltage of the second driving transistor DT2 charged in the second capacitor Cst2. During the fourth periods S14 and P14, the light-emitting element EL1 can emit light by a current generated according to the gate-to-source voltage of the first driving transistor DT1 charged in the first capacitor Cst1, and simultaneously, the light-emitting element EL2 can emit light by a current generated according to the gate-to-source voltage of the second driving transistor DT2 charged in the second capacitor Cst2. In this case, in a single sub-pixel, the first pixel data can be reproduced with a wide viewing angle, and the second pixel data can be reproduced with a narrow viewing angle. The first pixel data can be data of shared content, and the second pixel data can be data of personal content requiring privacy protection, but they are not limited thereto.

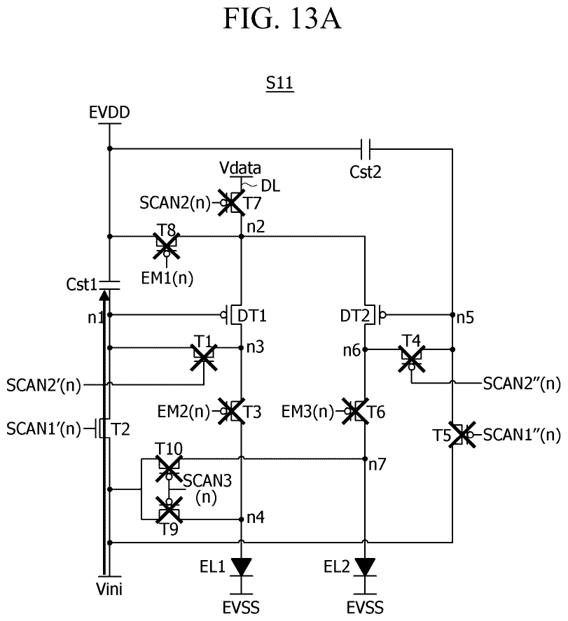

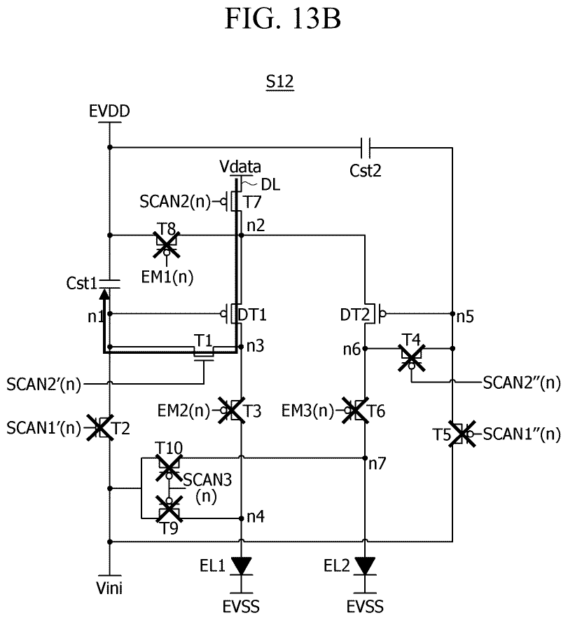

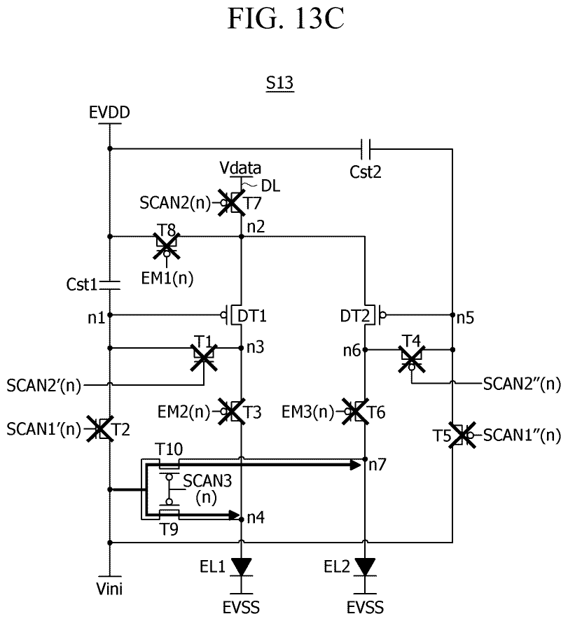

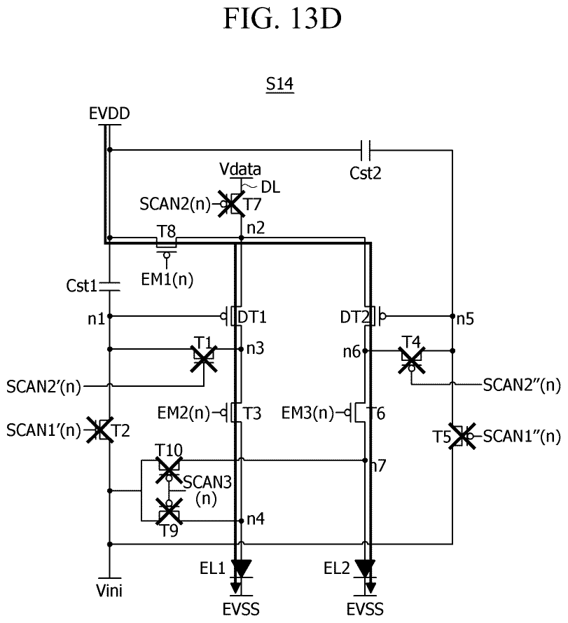

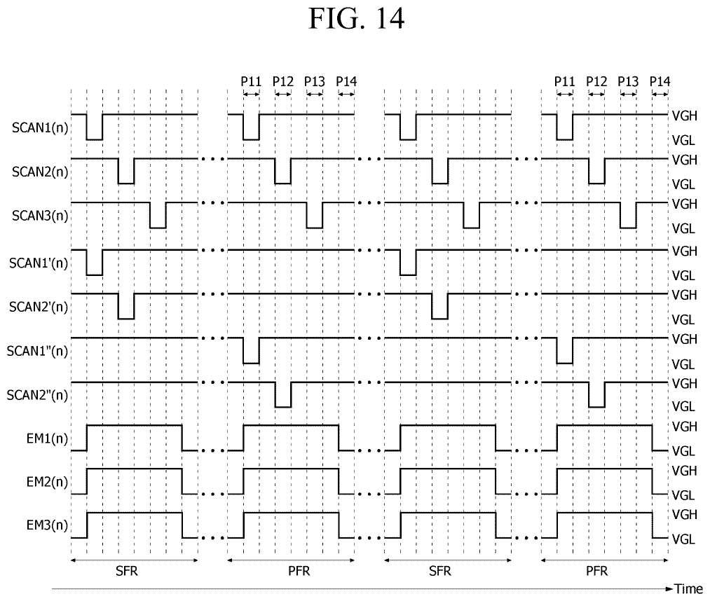

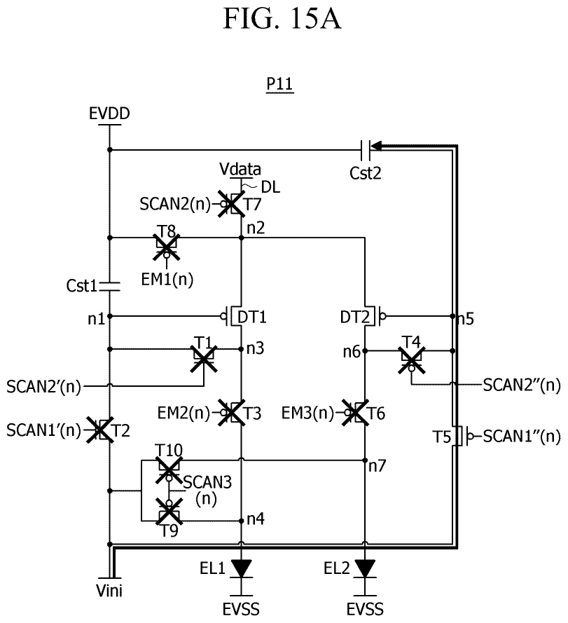

FIGS. 12 to 13D are diagrams illustrating in a stepwise manner, when the pixel circuit shown in FIG. 6 is alternately driven in a first viewing angle mode and a second viewing angle mode, the operation of the pixel circuit in the first viewing angle mode.

The pixel circuit can be alternately driven in the first viewing angle mode and the second viewing angle mode. For example, odd-numbered frame periods can be refresh frame periods of the first viewing angle mode, and even-numbered frame periods can be refresh frame periods of the second viewing angle mode. In this case, the pixel circuit can be driven at 60 Hz in each of the first viewing angle mode and the second viewing angle mode at one-frame period intervals.

FIGS. 13A to 13D are circuit diagrams illustrating the operation of the pixel circuit in stepwise manner during an odd-numbered frame period, in which the pixel circuit is driven in the first viewing angle mode, in the driving method shown in FIG. 12. An odd-numbered frame period SFR includes a first period S11, a second period S12, a third period S13, and a fourth period S14. In this embodiment, redundant descriptions with the foregoing embodiment can be omitted.

Referring to FIGS. 12 and 13A, during the first period S11 of the odd-numbered frame period SFR, the voltage of the first scan signal SCAN1(n) and the first-first scan signal SCAN1′(n) is at the gate-on voltage VGL, and the voltages of the other gate signals SCAN2(n), SCAN3(n), SCAN2′(n), SCAN1″(n), SCAN2″(n), EM1(n), EM2(n), and EM3(n) are at the gate-off voltage VGH. Accordingly, during the first period S11, the second switch transistor T2 is turned on, and the initialization voltage Vini is applied to the first node n1.

Referring to FIGS. 12 and 13B, during the second period S12, the voltages of the second scan signal SCAN2(n) and the second-first scan signal SCAN2′(n) are generated as pulses of the gate-on voltage VGL synchronized with the first data voltage Vdata, and the voltages of the other gate signals SCAN1(n), SCAN3(n), SCAN1′(n), SCAN1″(n), SCAN2″(n), EM1(n), EM2(n), and EM3(n) are at the gate-off voltage VGH. During the second period S12, the first and seventh switch transistors T1 and T7 are turned on, and the first data voltage Vdata is applied to the first, second, and third nodes n1, n2, and n3.

Referring to FIGS. 12 and 13C, during the third period S13, the voltage of the third scan signal SCAN3(n) is at the gate-on voltage VGL, and the voltages of the other gate signals SCAN1(n), SCAN2(n), SCAN1′(n), SCAN2′(n), SCAN1″(n), SCAN2″(n), EM1(n), EM2(n), and EM3(n) are at the gate-off voltage VGH. Accordingly, during the third period S13, the ninth and tenth switch transistors T9 and T10 are turned on, and the anode voltages of the first and second light-emitting elements EL1 and EL2 are reset to the initialization voltage Vini.

Referring to FIGS. 12 and 13D, during the fourth period S14, the voltages of the EM signals EM1(n), EM2(n), and EM3(n) are at the gate-on voltage VGL, and the voltages of the other gate signals SCAN1(n), SCAN2(n), SCAN3(n), SCAN1′(n), SCAN2′(n), SCAN1″(n), SCAN2″(n) are at the gate-off voltage VGH. During the fourth period S14, the third, sixth, and eighth switch transistors T3, T6, and T8 are turned on. In this case, the first light-emitting element EL1 can emit light by a current generated according to the gate-to-source voltage of the first driving transistor DT1 charged in the first capacitor Cst1, and simultaneously, the second light-emitting element EL2 can emit light by a current generated according to the gate-to-source voltage of the second driving transistor DT2 charged in the second capacitor Cst2. As a result, in a single pixel circuit, the first pixel data can be reproduced in a wide viewing angle, and the second pixel data can be reproduced in a narrow viewing angle. When the pixel emits light at high luminance, such as in high dynamic range (HDR), if the same voltage is applied to the first and second capacitors Cst1 and Cst2, the pixel can emit high luminance light based on the data voltage of the same pixel data.

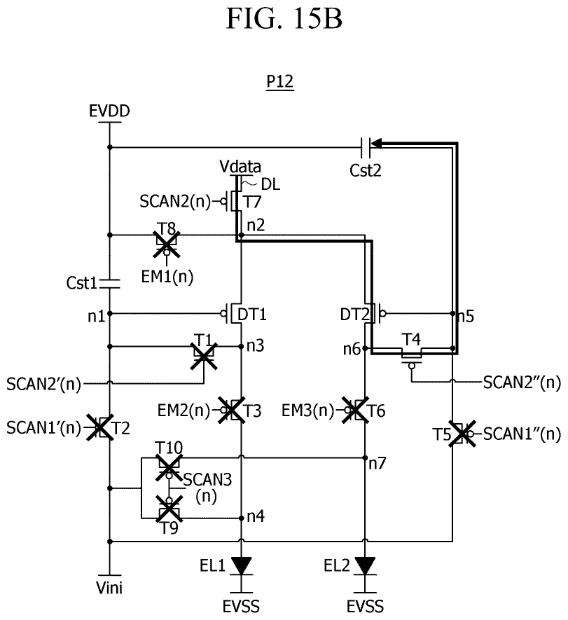

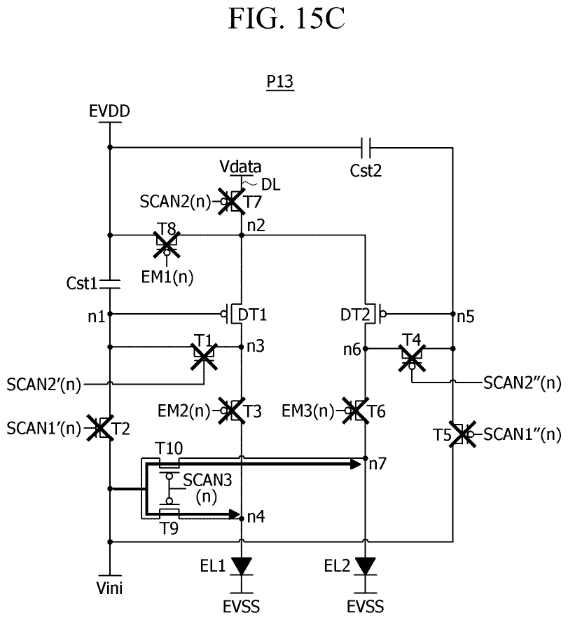

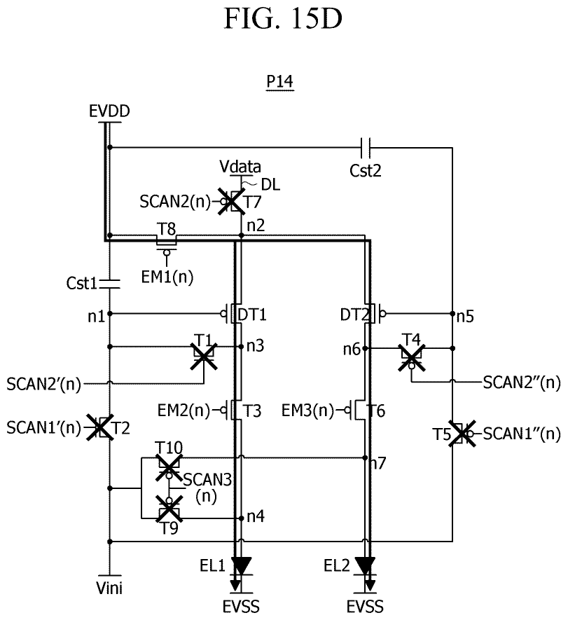

FIGS. 14 to 15D are diagrams in a stepwise manner, when the pixel circuit shown in FIG. 6 is alternately driven in a first viewing angle mode and a second viewing angle mode, the operation of the pixel circuit in the second viewing angle mode. In this embodiment, redundant descriptions with the above-described embodiment can be omitted. An even-numbered frame period PFR includes a first period P11, a second period P12, a third period P13, and a fourth period P14.

Referring to FIGS. 14 and 15A, during the first period P11 of the even-numbered frame period PFR, the voltage of the first scan signal SCAN1(n) and the first-second scan signal SCAN1″(n) is at the gate-on voltage VGL, and the voltages of the other gate signals SCAN2(n), SCAN3(n), SCAN1′(n), SCAN2′(n), SCAN2″(n), EM1(n), EM2(n), and EM3(n) are at the gate-off voltage VGH. Accordingly, during the first period P11, the fifth switch transistor T5 is turned on, and the initialization voltage Vini is applied to the fifth node n5.

Referring to FIGS. 14 and 15B, during the second period P12, the voltages of the second scan signal SCAN2(n) and the second-second scan signal SCAN2″(n) are generated as pulses of the gate-on voltage VGL synchronized with the second data voltage Vdata, and the voltages of the other gate signals SCAN1(n), SCAN3(n), SCAN1′(n), SCAN2′(n), SCAN1″(n), EM1(n), EM2(n), and EM3(n) are at the gate-off voltage VGH. During the second period P12, the fourth and seventh switch transistors T4 and T7 are turned on, so that the second data voltage Vdata is applied to the second, fifth, and sixth nodes n2, n5, and n6.

Referring to FIGS. 14 and 15C, during the third period P13, the voltage of the third scan signal SCAN3(n) is at the gate-on voltage VGL, and the voltages of the other gate signals SCAN1(n), SCAN2(n), SCAN1′(n), SCAN2′(n), SCAN1″(n), SCAN2″(n), EM1(n), EM2(n), and EM3(n) are at the gate-off voltage VGH. Accordingly, during the third period P13, the ninth and tenth switch transistors T9 and T10 are turned on, and the anode voltages of the first and second light-emitting elements EL1 and EL2 are reset to the initialization voltage Vini.

Referring to FIGS. 14 and 15D, during the fourth period P14, the voltages of the EM signals EM1(n), EM2(n), and EM3(n) are at the gate-on voltage VGL, and the voltages of the other gate signals SCAN1(n), SCAN2(n), SCAN3(n), SCAN1′(n), SCAN2′(n), SCAN1″(n), and SCAN2″(n) are at the gate-off voltage VGH. During the fourth period P14, the third, sixth, and eighth switch transistors T3, T6, and T8 are turned on, so that the first light-emitting element EL1 can emit light by a current generated according to the gate-to-source voltage of the first driving transistor DT1, and simultaneously, the second light-emitting element EL2 can emit light by a current generated according to the gate-to-source voltage of the second driving transistor DT2 charged in the second capacitor Cst2.

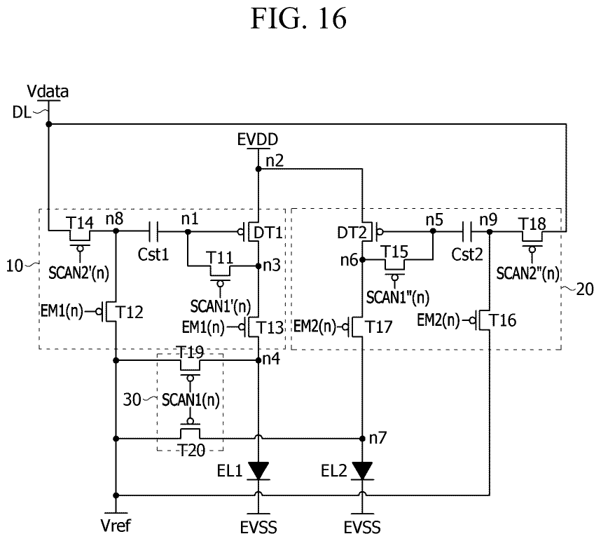

FIG. 16 is a circuit diagram illustrating in detail another example of the pixel circuit shown in FIG. 3. In this embodiment, redundant descriptions with the embodiment shown in FIG. 6 can be omitted.

Referring to FIG. 16, the pixel circuit includes a plurality of transistors DT1, DT2, and T11 to T20, a first capacitor Cst1, and a second capacitor Cst2. The transistors DT1, DT2, and T11 to T20 can be implemented as p-channel LTPS transistors, but are not limited thereto.

The first driver 10 includes a first driving transistor DT1, a first switch transistor T11, a second switch transistor T12, a third switch transistor T13, a fourth switch transistor T14, and the first capacitor Cst1.

The first driving transistor DT1 includes a gate electrode connected to a first node n1, a first electrode connected to a second node n2, and a second electrode connected to a third node n3. The first capacitor Cst1 is connected between the first node n1 and an eighth node n8. An anode electrode of the first light-emitting element EL1 is connected to a fourth node n4, and a cathode electrode thereof is connected to a second constant voltage node to which the cathode voltage EVSS is applied. The second node n2 is a first constant voltage node to which the pixel driving voltage EVDD is applied.

The first switch transistor T11 can be turned on in response to the gate-on voltage VGL of the first-first scan signal SCAN1′(n) and turned off in response to the gate-off voltage VGH. When the first switch transistor T11 is turned on, the first node n1 is electrically connected to the third node n3(The first switch transistor T11 includes a gate electrode connected to a gate line to which the first-first scan signal SCAN1′(n) is applied, a first electrode connected to the first node n1, and a second electrode connected to the third node n3.

The second switch transistor T12 is connected between the eighth node n8 and a third constant voltage node to which a reference voltage Vref is applied. The reference voltage Vref can be interpreted as the above-described initialization voltage. The reference voltage Vref can be set to a voltage lower than a lower limit voltage of the data voltage Vdata and close to the cathode voltage EVSS. The second switch transistor T12 can be turned on in response to the gate-on voltage VGL of the first EM signal EM1(n) and turned off in response to the gate-off voltage VGH. When the second switch transistor T12 is turned on, the reference voltage Vref is applied to the eighth node n8. The second switch transistor T12 includes a gate electrode connected to a gate line to which the first EM signal EM1(n) is applied, a first electrode connected to the eighth node n8, and a second electrode connected to the third constant voltage node.

The third switch transistor T13 is connected between the third node n3 and the fourth node n4. The third switch transistor T13 can be turned on in response to the gate-on voltage VGL of the first EM signal EM1(n), and turned off in response to the gate-off voltage VGH. When the third switch transistor T13 is turned on, the third node n3 can be electrically connected to the fourth node n4. The third switch transistor T13 includes a gate electrode connected to a gate line to which the first EM signal EM1(n) is applied, a first electrode connected to the third node n3, and a second electrode connected to the fourth node n4.

The fourth switch transistor T14 is connected between the data line DL to which the data voltage Vdata is applied, and the eighth node n8. The fourth switch transistor T14 can be turned on in response to the gate-on voltage VGL of the second-first scan signal SCAN2′(n), and turned off in response to the gate-off voltage VGH. When the fourth switch transistor T14 is turned on, the data voltage Vdata is applied to the eighth node n8. The fourth switch transistor T14 includes a gate electrode connected to a gate line to which the second-first scan signal SCAN2′(n) is applied, a first electrode connected to the data line DL, and a second electrode connected to the eighth node n8.

The second driver 20 includes a second driving transistor DT2, a fifth switch transistor T15, a sixth switch transistor T16, a seventh switch transistor T17, an eighth switch transistor T18, and the second capacitor Cst2.

The second driving transistor DT2 includes a gate electrode connected to a fifth node n5, a first electrode connected to the second node n2, and a second electrode connected to a sixth node n6. The second capacitor Cst2 is connected between the fifth node n5 and a ninth node n9. The anode electrode of the second light-emitting element EL2 is connected to a seventh node n7, and the cathode electrode thereof is connected to the second constant voltage node to which the cathode voltage EVSS is applied.

The fifth switch transistor T15 can be turned on in response to the gate-on voltage VGL of the first-second scan signal SCAN1″(n), and turned off in response to the gate-off voltage VGH. When the fifth switch transistor T15 is turned on, the fifth node n5 is electrically connected to the sixth node n6. The fifth switch transistor T15 includes a gate electrode connected to a gate line to which the first-second scan signal SCAN1″(n) is applied, a first electrode connected to the fifth node n5, and a second electrode connected to the sixth node n6.

The sixth switch transistor T16 is connected between the ninth node n9 and the third constant voltage node to which the reference voltage Vref is applied. The sixth switch transistor T16 can be turned on in response to the gate-on voltage VGL of the second EM signal EM2(n), and turned off in response to the gate-off voltage VGH. When the sixth switch transistor T16 is turned on, the reference voltage Vref is applied to the ninth node n9. The sixth switch transistor T16 includes a gate electrode connected to a gate line to which the second EM signal EM2(n) is applied, a first electrode connected to the ninth node n9, and a second electrode connected to the third constant voltage node.

The seventh switch transistor T17 is connected between the sixth node n6 and the seventh node n7. The seventh switch transistor T17 can be turned on in response to the gate-on voltage VGL of the second EM signal EM2(n) and turned off in response to the gate-off voltage VGH. When the seventh switch transistor T17 is turned on, the sixth node n6 can be electrically connected to the seventh node n7. The seventh switch transistor T17 includes a gate electrode connected to a gate line to which the second EM signal EM2(n) is applied, a first electrode connected to the sixth node n6, and a second electrode connected to the seventh node n7.

The eighth switch transistor T18 is connected between the data line DL to which the data voltage Vdata is applied and the ninth node n9. The eighth switch transistor T18 can be turned on in response to the gate-on voltage VGL of the second-second scan signal SCAN2″(n) and turned off in response to the gate-off voltage VGH. When the eighth switch transistor T18 is turned on, the data voltage Vdata is applied to the ninth node n9. The eighth switch transistor T18 includes a gate electrode connected to a gate line to which the second-second scan signal SCAN2″(n) is applied, a first electrode connected to the data line DL, and a second electrode connected to the ninth node n9.

The first-first, second-first, first-second and second-second scan signals SCAN1′(n), SCAN2′(n), SCAN1″(n), SCAN2″(n) are transmitted to the first and second drivers 10 and 20 through the multiplexer MUX shown in FIG. 5.

The shared switch portion 30 includes a ninth switch transistor T19 and a tenth switch transistor T20.

The ninth switch transistor T19 is connected between the third constant voltage node to which the reference voltage Vref is applied and the fourth node n4. The ninth switch transistor T19 can be turned on in response to the gate-on voltage VGL of the first scan signal SCAN1(n) and turned off in response to the gate-off voltage VGH. When the ninth switch transistor T19 is turned on, the fourth node n4 is reset to the reference voltage Vref. The ninth switch transistor T19 includes a gate electrode connected to a gate line to which the first scan signal SCAN1(n) is applied, a first electrode connected to the third constant voltage node, and a second electrode connected to the fourth node n4.

The tenth switch transistor T20 is connected between the third constant voltage node and the seventh node n7. The tenth switch transistor T20 can be turned on in response to the gate on voltage VGL of the first scan signal SCAN1(n) and turned off in response to the gate off voltage VGH. When the tenth switch transistor T20 is turned on, the seventh node n7 is reset to the reference voltage Vref. The tenth switch transistor T20 includes a gate electrode connected to a gate line to which the first scan signal SCAN1(n) is applied, a first electrode connected to the third constant voltage node, and a second electrode connected to the seventh node n7.

The output nodes of the signal transmission parts ST11 to ST1(n) of the first gate driver 121 shown in FIGS. 2A and 5 are connected to the gate electrodes of the ninth and tenth switch transistors T19 and T20 through the gate line. Accordingly, the first scan signal SCAN1(n) is applied to the gate electrodes of the ninth and tenth switch transistors T19 and T20 without passing through the multiplexer MUX. In the case of the pixel circuit shown in FIG. 16, the third gate driver 123 and the sixth gate driver 126 shown in FIGS. 2A and 2B are not required, making it easier to implement a narrow bezel design of the display panel.

The pixel circuit shown in FIG. 16 can be alternately driven in the first viewing angle mode and the second viewing angle mode. For example, an odd-numbered frame period can be a refresh frame period of the first viewing angle mode, and an even-numbered frame period can be a refresh frame period of the second viewing angle mode. In this case, the pixel circuit can be driven at 60 Hz in each of the first viewing angle mode and the second viewing angle mode at one-frame period intervals.

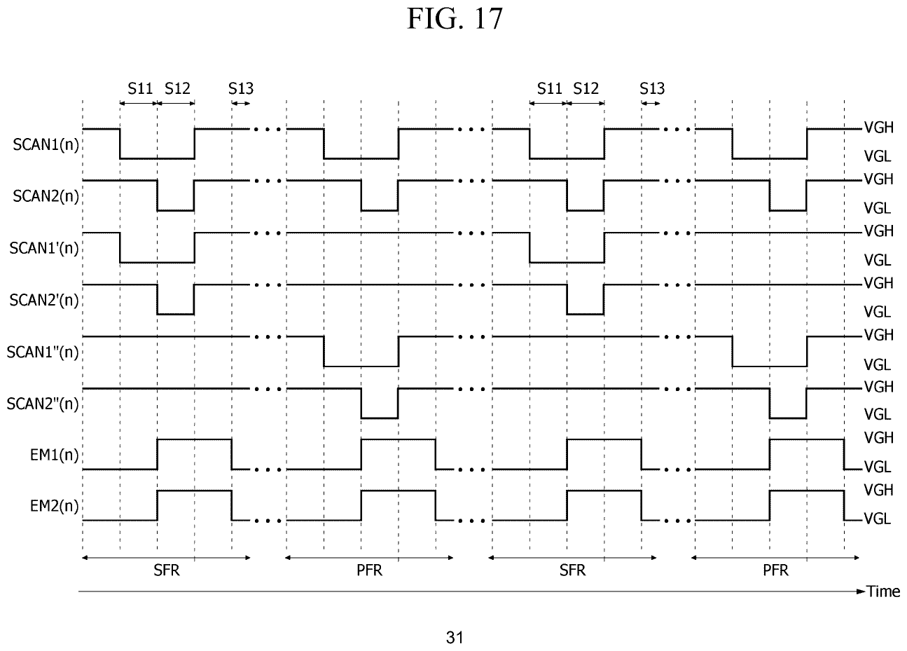

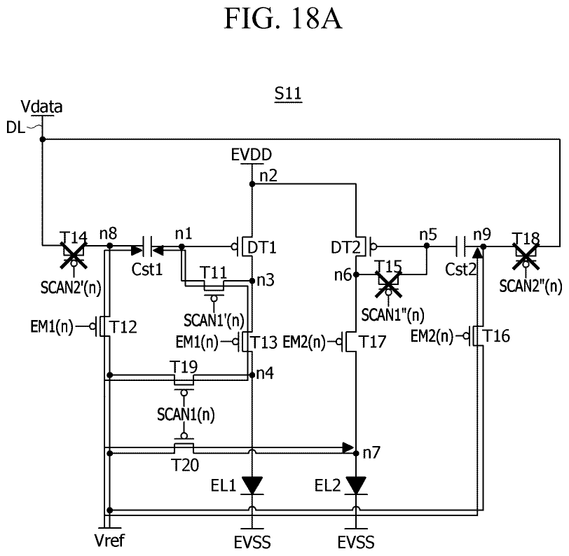

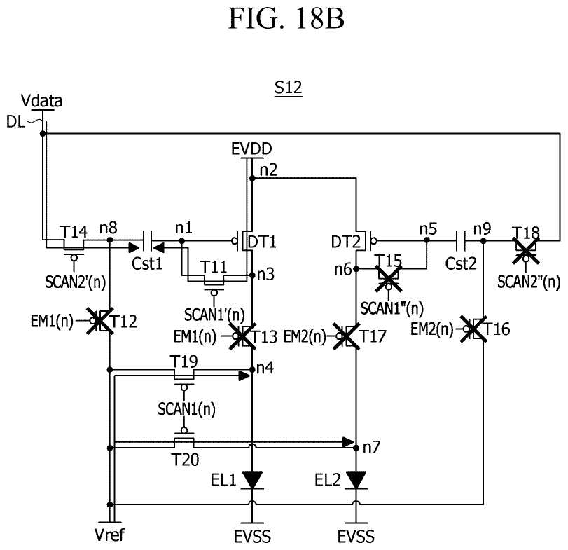

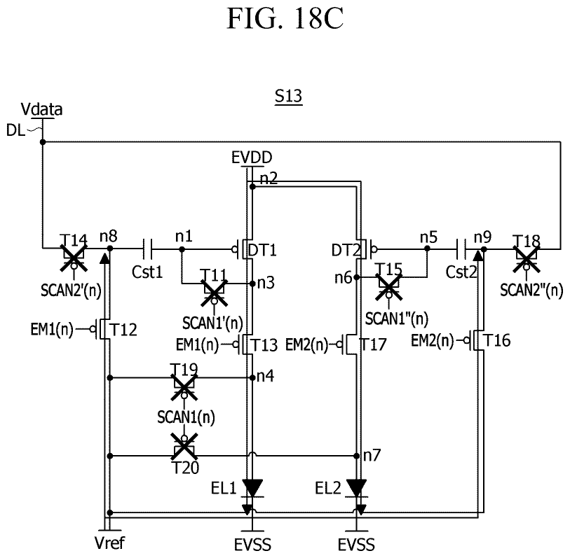

FIGS. 17 to 18C are diagrams illustrating in a stepwise manner, when the pixel circuit shown in FIG. 16 is alternately driven in a first viewing angle mode and a second viewing angle mode, the operation of the pixel circuit in the first viewing angle mode. The odd-numbered frame period SFR can include a first period S11, a second period S12, and a third period S13.

Referring to FIGS. 17 and 18A, during the first period S11 of the odd-numbered frame period SFR, the voltages of the first scan signal SCAN1(n), the first-first scan signal SCAN1′(n), the first EM signal EM1, and the second EM signal EM2 are at the gate-on voltage VGL, and the voltages of the other gate signals SCAN2(n), SCAN2′(n), SCAN1″(n), and SCAN2″(n) are at the gate-off voltage VGH. Accordingly, during the first period S11, the first switch transistor T11, the second switch transistor T12, the third switch transistor T13, the sixth switch transistor T16, the seventh switch transistor T17, the ninth switch transistor T19, and the tenth switch transistor T20 are turned on, so that the first node n1, the third node n3, the fourth node n4, the sixth node n6, the seventh node n7, the eighth node n8, and the ninth node n9 are initialized to the reference voltage Vref.

Referring to FIGS. 17 and 18B, during the second period S12, the voltages of the first scan signal SCAN1(n), the second scan signal SCAN2(n), the first-first scan signal SCAN1′(n), and the second-first scan signal SCAN2′(n) are generated as pulses of the gate-on voltage VGL synchronized with the data voltage Vdata, and the voltages of the other gate signals SCAN1″(n), SCAN2″(n), EM1(n), and EM2(n) are at the gate-off voltage VGH. During the second period S12, the first and fourth switch transistors T11 and T14 are turned on, so that the first data voltage Vdata, compensated by the threshold voltage of the first driving transistor DT1 is charged in the first capacitor Cst1, and the ninth and tenth switch transistors T19 and T20 are turned on, so that the reference voltage Vref is applied to the fourth and seventh nodes n4 and n7, thereby resetting the anode voltages of the first and second light-emitting elements EL1 and EL2 to the reference voltage Vref.

Referring to FIGS. 17 and 18C, during the third period S13, the voltages of the first and second EM signals EM1(n) and EM2(n) are at the gate-on voltage VGL, and the voltages of the other gate signals SCAN1(n), SCAN2(n), SCAN1′(n), SCAN2′(n), SCAN1″(n), and SCAN2″(n) are at the gate-off voltage VGH. During the third period S13, the second, third, sixth, and seventh switch transistors T12, T13, T16, and T17 are turned on. In this case, the first light-emitting element EL1 can emit light by a current generated according to the gate-to-source voltage of the first driving transistor DT1 charged in the first capacitor Cst1, and simultaneously, the second light-emitting element EL2 can emit light by a current generated according to the gate-to-source voltage of the second driving transistor DT2 charged in the second capacitor Cst2.

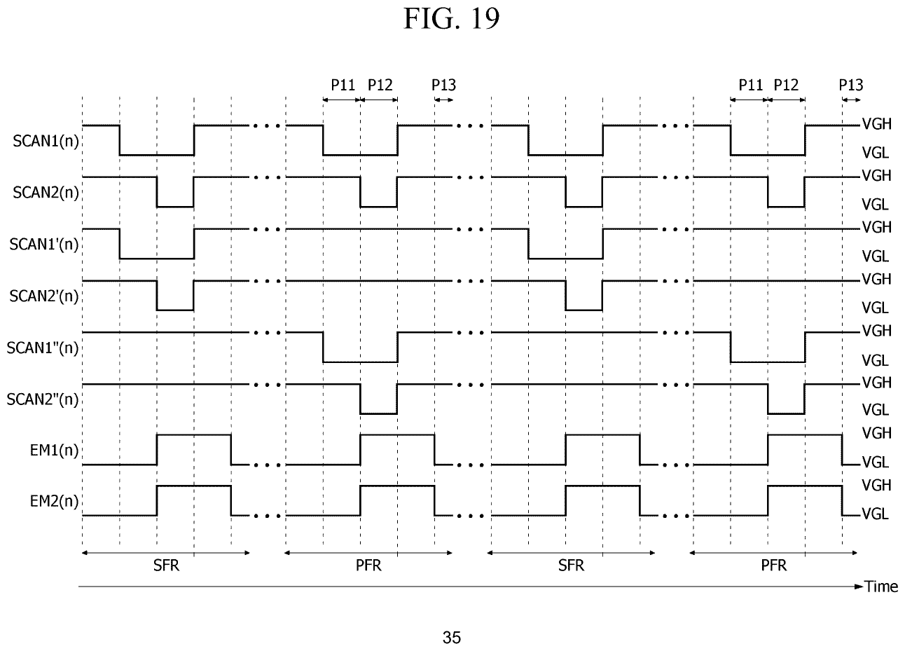

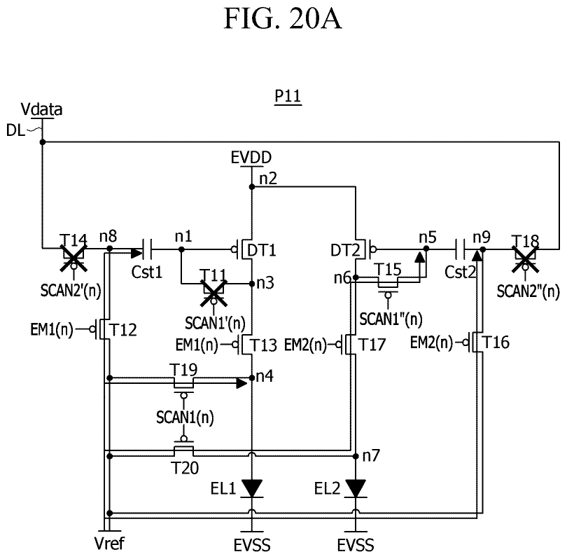

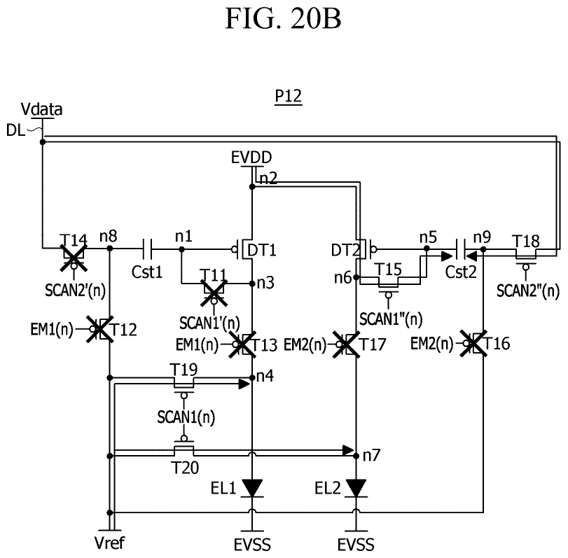

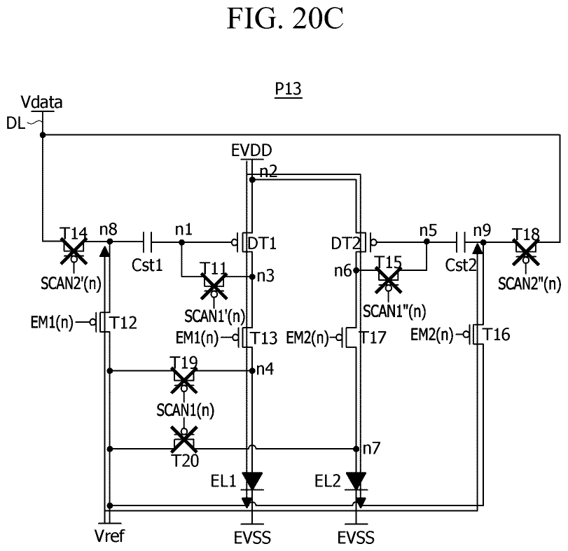

FIGS. 19 to 20C are diagrams illustrating in a stepwise manner, when the pixel circuit shown in FIG. 16 is alternately driven in a first viewing angle mode and a second viewing angle mode, the operation of the pixel circuit in the second viewing angle mode. In this embodiment, redundant descriptions with the above-described embodiments can be omitted. The even-numbered frame period PFR can include a first period P11, a second period P12, and a third period P13.

Referring to FIGS. 19 and 20A, during the first period P11 of the even-numbered frame period PFR, the voltages of the first scan signal SCAN1(n), the first-second scan signal SCAN1″(n), the first EM signal EM1(n), and the second EM signal EM2(n) are at the gate-on voltage VGL, and the voltages of the other gate signals SCAN2(n), SCAN1′(n), SCAN2′(n), and SCAN2″(n) are at the gate-off voltage VGH. Accordingly, during the first period P11, the second switch transistor T12, the third switch transistor T13, the fifth switch transistor T15, the sixth switch transistor T16, the seventh switch transistor T17, the ninth switch transistor T19, and the tenth switch transistor T20 are turned on, so that the fourth node n4, the fifth node n5, the sixth node n6, the seventh node n7, the eighth node n8, and the ninth node n9 are initialized to the reference voltage Vref.

Referring to FIGS. 19 and 20B, during the second period P12, the voltages of the first scan signal SCAN1(n), the second scan signal SCAN2(n), the first-second scan signal SCAN1″(n), and the second-second scan signal SCAN2″(n) are generated as pulses of the gate-on voltage VGL synchronized with the data voltage Vdata, and the voltages of the other gate signals SCAN1′(n), SCAN2′(n), EM1(n), and EM2(n) are at the gate-off voltage VGH. During the second period P12, the fifth and eighth switch transistors T5 and T8 are turned on, so that the second data voltage Vdata compensated by the threshold voltage of the second driving transistor DT2 is charged in the second capacitor Cst2, and the ninth and tenth switch transistors T19 and T20 are turned on, so that the reference voltage Vref is applied to the fourth and seventh nodes n4 and n7, thereby resetting the anode voltages of the first and second light-emitting elements EL1 and EL2 to the reference voltage Vref.

Referring to FIGS. 19 and 20C, during the third period P13, the voltages of the first and second EM signals EM1(n) and EM2(n) are at the gate-on voltage VGL, and the voltages of the other gate signals SCAN1(n), SCAN2(n), SCAN1′(n), SCAN2′(n), SCAN1″(n), and SCAN2″(n) are at the gate-off voltage VGH. During the third period P13, the second, third, sixth, and seventh switch transistors T2, T3, T6, and T7 are turned on. In this case, the first light-emitting element EL1 can emit light by a current generated according to the gate-to-source voltage of the first driving transistor DT1 charged in the first capacitor Cst1, and simultaneously, the second light-emitting element EL2 can emit light by a current generated according to the gate-to-source voltage of the second driving transistor DT2 charged in the second capacitor Cst2.

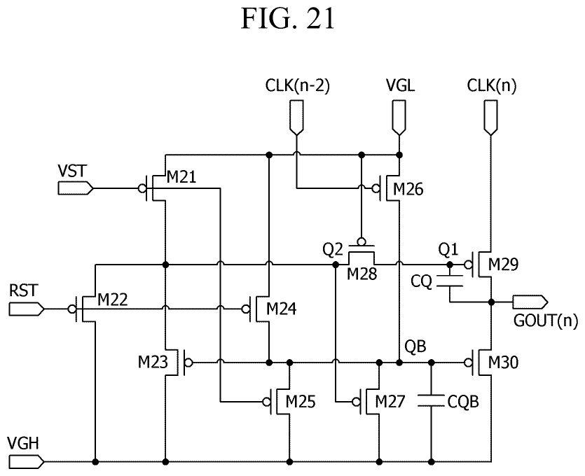

FIG. 21 is a circuit diagram illustrating an example of the signal transmission part shown in FIG. 5. It should be noted that the gate driver of the present disclosure is not limited to the circuit shown in FIG. 21. For example, the circuit of the signal transmission part of the gate driver can be implemented as a shift register or an edge trigger circuit for driving the gate lines of a known display panel.

Referring to FIG. 21, the signal transmission part includes a Q1 node, a Q2 node, a QB node, and a plurality of transistors M21 to M30. Each of the transistors M21 to M30 can be implemented as a p-channel transistor, but is not limited thereto.

A first transistor M21 is connected between a VGL node and the Q2 node, and is turned on in response to the gate-on voltage VGL of a start signal VST or a carry signal inputted from a previous signal transmission part, thereby electrically connecting the VGL node to the Q2 node. The gate-on voltage VGL is applied to the VGL node. The start signal VST or the carry signal inputted from the previous signal transmission part is inputted to a VST node. The first transistor M21 includes a gate electrode connected to the VST node, a first electrode connected to the VGL node, and a second electrode connected to the Q2 node.

A second transistor M22 is connected between a VGH node and the Q2 node, and is turned on in response to the gate-on voltage VGL of a reset signal RST, thereby electrically connecting the Q2 node to the VGH node. The gate-off voltage VGH is applied to the VGH node. The second transistor M22 includes a gate electrode connected to an RST node to which the reset signal RST is inputted, a first electrode connected to the Q2 node, and a second electrode connected to the VGH node.

A third transistor M23 is connected between the Q2 node and the VGH node, and is turned on in response to the gate-on voltage VGL of the QB node, thereby electrically connecting the Q2 node to the VGH node. The third transistor M23 includes a gate electrode connected to the QB node, a first electrode connected to the Q2 node, and a second electrode connected to the VGH node.

A fourth transistor M24 is connected between the VGL node and the QB node, and is turned on in response to the gate-on voltage VGL of the reset signal RST, thereby electrically connecting the QB node to the VGL node. The fourth transistor M24 includes a gate electrode connected to the RST node, a first electrode connected to the VGL node, and a second electrode connected to the QB node.

A fifth transistor M25 is connected between the QB node and the VGH node, and is turned on in response to the gate-on voltage VGL of the start signal VST or the carry signal inputted from the previous signal transmission part, thereby electrically connecting the QB node to the VGH node. The fifth transistor M25 includes a gate electrode connected to the VST node, a first electrode connected to the QB node, and a second electrode connected to the VGH node.

A sixth transistor M26 is connected between the VGL node and the QB node, and is turned on in response to the gate-on voltage VGL of an (n−2)^{th} clock CLK(n−2), thereby electrically connecting the QB node to the VGL node. The sixth transistor M26 includes a gate electrode connected to a first clock node to which the (n−2)^{th} clock CLK(n−2) is inputted, a first electrode connected to the VGL node, and a second electrode connected to the QB node.

A seventh transistor M27 is connected between the QB node and the VGH node, and is turned on in response to the gate-on voltage VGL of the Q2 node, thereby electrically connecting the QB node to the VGH node. The seventh transistor M27 includes a gate electrode connected to the Q2 node, a first electrode connected to the QB node, and a second electrode connected to the VGH node.

An eighth transistor M28 is connected between the Q1 node and the Q2 node. When the voltage of the Q1 node is charged to the gate-on voltage VGL, and an nth clock CLK(n) is inputted as a pulse of the gate-on voltage VGL, bootstrapping occurs through a ninth transistor M29 and a capacitor CQ, and the voltage of the Q1 node is boosted to a voltage lower than the gate-on voltage VGL. When the voltage of the Q1 node is bootstrapped, the eighth transistor M28 electrically isolates the Q1 node from the Q2 node to prevent the voltage of the Q2 node from being bootstrapped. The eighth transistor M28 includes a gate electrode connected to the VGL node, a first electrode connected to the Q1 node, and a second electrode connected to the Q2 node.

The ninth and tenth transistors M29 and M30 are output buffer transistors for outputting an nth pulse of a gate signal GOUT(n) through an output node. The ninth transistor M29 is connected between a second clock node to which the nth clock CLK(n) is inputted and the output node, and is turned on in response to the voltage of the Q1 node. When the voltage of the Q1 node is the gate-on voltage VGL, the ninth transistor M29 is turned on, so that the second clock node can be electrically connected to the output node to transmit the voltage of the nth clock CLK(n) to the output node. The ninth transistor M29 includes a gate electrode connected to the Q1 node, a first electrode connected to the second clock node, and a second electrode connected to the output node. The capacitor CQ is connected between the Q1 node and the output node. The capacitor CQ is connected between the output node and the Q1 node to generate bootstrapping.

The tenth transistor M30 is connected between the output node and the VGH node and is turned on in response to the gate-on voltage VGL of the QB node. When the voltage of the QB node is the gate-on voltage VGL, the tenth transistor M30 is turned on, so that the output node is electrically connected to the VGH node. The tenth transistor M30 includes a gate electrode connected to the QB node, a first electrode connected to the output node, and a second electrode connected to the VGH node. A capacitor CQB is connected between the QB node and the VGH node to reduce the variation in the gate-to-source voltage of the tenth transistor M30.

According to one or more embodiments of the present disclosure, the display device can be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure can be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the detailed description of the present disclosure.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display panel comprising:
a pixel circuit connected to a data line, a plurality of gate lines, a plurality of constant voltage nodes, a first light-emitting element, and a second light-emitting element;
a first gate driver configured to output a first scan signal;
a second gate driver configured to output a second scan signal; and
a multiplexer configured to select one of the first scan signal, the second scan signal, and a gate-off voltage and output the selected one of the first scan signal, the second scan signal, and the gate-off voltage to a corresponding gate line among the plurality of gate lines.

2. The display panel of claim 1, wherein the multiplexer is configured to:
select one of the first scan signal and the gate-off voltage and output a first-first scan signal to a first gate line among the plurality of gate lines;
select one of the second scan signal and the gate-off voltage and output a second-first scan signal to a second gate line among the plurality of gate lines;
select one of the first scan signal and the gate-off voltage and output a first-second scan signal to a third gate line among the plurality of gate lines; and
select one of the second scan signal and the gate-off voltage and output a second-second scan signal to a fourth gate line among the plurality of gate lines.

3. The display panel of claim 2, wherein the pixel circuit includes:
a first driver connected to the first gate line, the second gate line, and the first light-emitting element;
a second driver connected to the third gate line, the fourth gate line, and the second light-emitting element; and
a shared switch part connected to the data line, the first driver, and the second driver.

4. The display panel of claim 3, further comprising:
a third gate driver configured to output a third scan signal;
a fourth gate driver configured to output a first emission signal;
a fifth gate driver configured to output a second emission signal; and
a sixth gate driver configured to output a third emission signal.

5. The display panel of claim 4, wherein the first driver of the pixel circuit includes:
a first driving transistor including a gate electrode connected to a first node, a first electrode connected to a second node, and a second electrode connected to a third node;
a first capacitor connected between a first constant voltage node and the first node;
a first switch transistor including a gate electrode connected to the second gate line to which the second-first scan signal is applied, a first electrode connected to the first node, and a second electrode connected to the third node;
a second switch transistor including a gate electrode connected to the first gate line to which the first-first scan signal is applied, a first electrode connected to the first node, and a second electrode connected to a third constant voltage node; and
a third switch transistor including a gate electrode to which the second emission signal is applied, a first electrode connected to the third node, and a second electrode connected to a fourth node,
wherein the first light-emitting element includes an anode electrode connected to the fourth node and a cathode electrode connected to a second constant voltage node, and
wherein each of the first switch transistor, the second switch transistor, and the third switch transistor is turned on in response to a gate-on voltage and is turned off in response to the gate-off voltage.

6. The display panel of claim 5, wherein the second driver of the pixel circuit includes:
a second driving transistor including a gate electrode connected to a fifth node, a first electrode connected to the second node, and a second electrode connected to a sixth node;
a second capacitor connected between the first constant voltage node and the fifth node;
a fourth switch transistor including a gate electrode connected to the fourth gate line to which the second-second scan signal is applied, a first electrode connected to the fifth node, and a second electrode connected to the sixth node;
a fifth switch transistor including a gate electrode connected to the third gate line to which the first-second scan signal is applied, a first electrode connected to the fifth node, and a second electrode connected to the third constant voltage node; and
a sixth switch transistor including a gate electrode to which the third emission signal is applied, a first electrode connected to the sixth node, and a second electrode connected to a seventh node,
wherein the second light-emitting element includes an anode electrode connected to the seventh node and a cathode electrode connected to the second constant voltage node, and
wherein each of the fourth switch transistor, the fifth switch transistor, and the sixth switch transistor is turned on in response to the gate-on voltage and is turned off in response to the gate-off voltage.

7. The display panel of claim 6, wherein the shared switch part of the pixel circuit includes:
a seventh switch transistor including a gate electrode to which the second scan signal is applied, a first electrode connected to the data line, and a second electrode connected to the second node;
an eighth switch transistor including a gate electrode to which the first emission signal is applied, a first electrode connected to the first constant voltage node, and a second electrode connected to the second node;
a ninth switch transistor including a gate electrode to which the third scan signal is applied, a first electrode connected to the third constant voltage node, and a second electrode connected to the fourth node; and
a tenth switch transistor including a gate electrode to which the third scan signal is applied, a first electrode connected to the third constant voltage node, and a second electrode connected to the seventh node,
wherein each of the seventh switch transistor, the eighth switch transistor, the ninth switch transistor, and the tenth switch transistor is turned on in response to the gate-on voltage and is turned off in response to the gate-off voltage.

8. The display panel of claim 3, further comprising:
a third gate driver configured to output a first emission signal; and
a fourth gate driver configured to output a second emission signal.

9. The display panel of claim 8, wherein the first driver of the pixel circuit includes:
a first driving transistor including a gate electrode connected to a first node, a first electrode connected to a second node to which a constant voltage is applied, and a second electrode connected to a third node;
a first capacitor connected between the first node and an eighth node;
a first switch transistor including a gate electrode connected to the first gate line to which the first-first scan signal is applied, a first electrode connected to the first node, and a second electrode connected to the third node;
a second switch transistor including a gate electrode to which the first emission signal is applied, a first electrode connected to the eighth node, and a second electrode connected to a third constant voltage node;
a third switch transistor including a gate electrode to which the first emission signal is applied, a first electrode connected to the third node, and a second electrode connected to a fourth node; and
a fourth switch transistor including a gate electrode connected to the second gate line to which the second-first scan signal is applied, a first electrode connected to the data line, and a second electrode connected to the eighth node,
wherein the first light-emitting element includes an anode electrode connected to the fourth node and a cathode electrode connected to a second constant voltage node, and
wherein each of the first switch transistor, the second switch transistor, the third switch transistor, and the fourth switch transistor is turned on in response to a gate-on voltage and is turned off in response to the gate-off voltage.

10. The display panel of claim 9, wherein the second driver of the pixel circuit includes:
a second driving transistor including a gate electrode connected to a fifth node, a first electrode connected to the second node, and a second electrode connected to a sixth node;
a second capacitor connected between the fifth node and a ninth node;
a fifth switch transistor including a gate electrode connected to the third gate line to which the first-second scan signal is applied, a first electrode connected to the fifth node, and a second electrode connected to the sixth node;
a sixth switch transistor including a gate electrode to which the second emission signal is applied, a first electrode connected to the ninth node, and a second electrode connected to the third constant voltage node;
a seventh switch transistor including a gate electrode to which the second emission signal is applied, a first electrode connected to the sixth node, and a second electrode connected to a seventh node; and
an eighth switch transistor including a gate electrode connected to the fourth gate line to which the second-second scan signal is applied, a first electrode connected to the data line, and a second electrode connected to the ninth node,
wherein the second light-emitting element includes an anode electrode connected to the seventh node and a cathode electrode connected to the second constant voltage node, and
wherein each of the fifth switch transistor, the sixth switch transistor, the seventh switch transistor, and the eighth switch transistor is turned on in response to the gate-on voltage and is turned off in response to the gate-off voltage.

11. The display panel of claim 10, wherein the shared switch part of the pixel circuit includes:
a ninth switch transistor including a gate electrode to which the first scan signal is applied, a first electrode connected to the third constant voltage node, and a second electrode connected to the fourth node; and
a tenth switch transistor including a gate electrode to which the first scan signal is applied, a first electrode connected to the third constant voltage node, and a second electrode connected to the seventh node, and
wherein each of the ninth switch transistor and the tenth switch transistor is turned on in response to the gate-on voltage and is turned off in response to the gate-off voltage.

12. A display device comprising:
a display panel in which a pixel circuit connected to a data line, a plurality of gate lines, a plurality of constant voltage nodes, a first light-emitting element, and a second light-emitting element is arranged,
wherein the display panel includes:
a first gate driver configured to output a first scan signal,
a second gate driver configured to output a second scan signal, and
a multiplexer configured to select one of the first scan signal, the second scan signal, and a gate-off voltage and output the selected one of the first scan signal, the second scan signal, and the gate-off voltage to a corresponding gate line among the plurality of gate lines; and
a data driver configured to supply a data voltage to the data line.

13. The display device of claim 12, wherein the multiplexer is configured to:
select one of the first scan signal and the gate-off voltage and output a first-first scan signal to a first gate line among the plurality of gate lines;
select one of the second scan signal and the gate-off voltage and output a second-first scan signal to a second gate line among the plurality of gate lines;
select one of the first scan signal and the gate-off voltage and output a first-second scan signal to a third gate line among the plurality of gate lines; and
select one of the second scan signal and the gate-off voltage and output a second-second scan signal to a fourth gate line among the plurality of gate lines.

14. The display device of claim 13, wherein the display panel further includes:
a third gate driver configured to output a third scan signal;
a fourth gate driver configured to output a first emission signal;
a fifth gate driver configured to output a second emission signal; and
a sixth gate driver configured to output a third emission signal, and
wherein the pixel circuit includes:
a first driver connected to the first gate line, the second gate line, and the first light-emitting element;
a second driver connected to the third gate line, the fourth gate line, and the second light-emitting element; and
a shared switch part connected to the data line, the first driver, and the second driver.

15. The display device of claim 14, wherein the first driver of the pixel circuit includes:
a first driving transistor including a gate electrode connected to a first node, a first electrode connected to a second node, and a second electrode connected to a third node;
a first capacitor connected between a first constant voltage node and the first node;
a first switch transistor including a gate electrode connected to the second gate line to which the second-first scan signal is applied, a first electrode connected to the first node, and a second electrode connected to the third node;
a second switch transistor including a gate electrode connected to the first gate line to which the first-first scan signal is applied, a first electrode connected to the first node, and a second electrode connected to a third constant voltage node; and
a third switch transistor including a gate electrode to which the second emission signal is applied, a first electrode connected to the third node, and a second electrode connected to a fourth node,
wherein the second driver of the pixel circuit includes:
a second driving transistor including a gate electrode connected to a fifth node, a first electrode connected to the second node, and a second electrode connected to a sixth node;
a second capacitor connected between the first constant voltage node and the fifth node;
a fourth switch transistor including a gate electrode connected to the fourth gate line to which the second-second scan signal is applied, a first electrode connected to the fifth node, and a second electrode connected to the sixth node;
a fifth switch transistor including a gate electrode connected to the third gate line to which the first-second scan signal is applied, a first electrode connected to the fifth node, and a second electrode connected to the third constant voltage node; and
a sixth switch transistor including a gate electrode to which the third emission signal is applied, a first electrode connected to the sixth node, and a second electrode connected to a seventh node, and
wherein the shared switch part of the pixel circuit includes:
a seventh switch transistor including a gate electrode to which the second scan signal is applied, a first electrode connected to the data line, and a second electrode connected to the second node;
an eighth switch transistor including a gate electrode to which the first emission signal is applied, a first electrode connected to the first constant voltage node, and a second electrode connected to the second node;
a ninth switch transistor including a gate electrode to which the third scan signal is applied, a first electrode connected to the third constant voltage node, and a second electrode connected to the fourth node; and
a tenth switch transistor including a gate electrode to which the third scan signal is applied, a first electrode connected to the third constant voltage node, and a second electrode connected to the seventh node.

16. The display device of claim 15, wherein:
the first light-emitting element includes an anode electrode connected to the fourth node and a cathode electrode connected to a second constant voltage node,
the second light-emitting element includes an anode electrode connected to the seventh node and a cathode electrode connected to the second constant voltage node, and
each of the first to tenth switch transistors is turned on in response to a gate-on voltage and is turned off in response to the gate-off voltage.

17. The display device of claim 16, wherein the pixel circuit is driven in a first viewing angle mode during a first refresh frame period and is driven in a second viewing angle mode during a second refresh frame period, and
wherein during a first period of the first refresh frame period, voltages of the first scan signal and the first-first scan signal are at the gate-on voltage, and voltages of the second scan signal, the third scan signal, the second-first scan signal, the first-second scan signal, the second-second scan signal, the first emission signal, the second emission signal, and the third emission signal are at the gate-off voltage,
during a second period of the first refresh frame period, voltages of the second scan signal and the second-first scan signal are at the gate-on voltage synchronized with the data voltage, and voltages of the first scan signal, the third scan signal, the first-first scan signal, the first-second scan signal, the second-second scan signal, the first emission signal, the second emission signal, and the third emission signal are at the gate-off voltage,
during a third period of the first refresh frame period, a voltage of the third scan signal is at the gate-on voltage, and voltages of the first scan signal, the second scan signal, the first-first scan signal, the second-first scan signal, the first-second scan signal, the second-second scan signal, the first emission signal, the second emission signal, and the third emission signal are at the gate-off voltage, and
during a fourth period of the first refresh frame period, voltages of the first emission signal and the second emission signal are at the gate-on voltage, voltages of the first scan signal, the second scan signal, the third scan signal, the first-first scan signal, the second-first scan signal, the first-second scan signal, and the second-second scan signal are at the gate-off voltage, and a voltage of the third emission signal is at the gate-off voltage or the gate-on voltage.

18. The display device of claim 17, wherein during a first period of the second refresh frame period, voltages of the first scan signal and the first-second scan signal are at the gate-on voltage, and voltages of the second scan signal, the third scan signal, the first-first scan signal, the second-first scan signal, the second-second scan signal, the first emission signal, the second emission signal, and the third emission signal are at the gate-off voltage,
during a second period of the second refresh frame period, voltages of the second scan signal and the second-second scan signal are at the gate-on voltage synchronized with the data voltage, and voltages of the first scan signal, the third scan signal, the first-first scan signal, the second-first scan signal, the first-second scan signal, the first emission signal, the second emission signal, and the third emission signal are at the gate-off voltage,
during a third period of the second refresh frame period, a voltage of the third scan signal is at the gate-on voltage, and voltages of the first scan signal, the second scan signal, the first-first scan signal, the second-first scan signal, the first-second scan signal, the second-second scan signal, the first emission signal, the second emission signal, and the third emission signal are at the gate-off voltage, and
during a fourth period of the second refresh frame period, voltages of the first emission signal and the third emission signal are at the gate-on voltage, voltages of the first scan signal, the second scan signal, the third scan signal, the first-first scan signal, the second-first scan signal, the first-second scan signal, and the second-second scan signal are at the gate-off voltage, and a voltage of the second emission signal is at the gate-off voltage or the gate-on voltage.

19. The display device of claim 13, wherein the display panel further includes:
a third gate driver configured to output a first emission signal; and
a fourth gate driver configured to output a second emission signal, and
wherein the pixel circuit includes:
a first driver connected to the first gate line, the second gate line, and the first light-emitting element;
a second driver connected to the third gate line, the fourth gate line, and the second light-emitting element; and
a shared switch part connected to the data line, the first driver, and the second driver.

20. The display device of claim 19, wherein the first driver of the pixel circuit includes:
a first driving transistor including a gate electrode connected to a first node, a first electrode connected to a second node to which a constant voltage is applied, and a second electrode connected to a third node;
a first capacitor connected between the first node and an eighth node;
a first switch transistor including a gate electrode connected to the first gate line to which the first-first scan signal is applied, a first electrode connected to the first node, and a second electrode connected to the third node;
a second switch transistor including a gate electrode to which the first emission signal is applied, a first electrode connected to the eighth node, and a second electrode connected to a third constant voltage node;
a third switch transistor including a gate electrode to which the first emission signal is applied, a first electrode connected to the third node, and a second electrode connected to a fourth node; and
a fourth switch transistor including a gate electrode connected to the second gate line to which the second-first scan signal is applied, a first electrode connected to the data line, and a second electrode connected to the eighth node,
wherein the second driver of the pixel circuit includes:
a second driving transistor including a gate electrode connected to a fifth node, a first electrode connected to the second node, and a second electrode connected to a sixth node;
a second capacitor connected between the fifth node and a ninth node;
a fifth switch transistor including a gate electrode connected to the third gate line to which the first-second scan signal is applied, a first electrode connected to the fifth node, and a second electrode connected to the sixth node;
a sixth switch transistor including a gate electrode to which the second emission signal is applied, a first electrode connected to the ninth node, and a second electrode connected to the third constant voltage node;
a seventh switch transistor including a gate electrode to which the second emission signal is applied, a first electrode connected to the sixth node, and a second electrode connected to a seventh node; and
an eighth switch transistor including a gate electrode connected to the fourth gate line to which the second-second scan signal is applied, a first electrode connected to the data line, and a second electrode connected to the ninth node,
wherein the shared switch part of the pixel circuit includes:
a ninth switch transistor including a gate electrode to which the first scan signal is applied, a first electrode connected to the third constant voltage node, and a second electrode connected to the fourth node; and
a tenth switch transistor including a gate electrode to which the first scan signal is applied, a first electrode connected to the third constant voltage node, and a second electrode connected to the seventh node,
wherein the first light-emitting element includes an anode electrode connected to the fourth node and a cathode electrode connected to a second constant voltage node,
wherein the second light-emitting element includes an anode electrode connected to the seventh node and a cathode electrode connected to the second constant voltage node, and
wherein each of the first to tenth switch transistors is turned on in response to a gate-on voltage and is turned off in response to the gate-off voltage.
